(19) United States
(12) Patent Application Publication
(10) Pub. No.: US 2026/0167548 A1
(43) Pub. Date: Jun. 18, 2026

(54) METHOD FOR MANUFACTURING MEMBER, APPARATUS FOR MANUFACTURING MEMBER, PREFORM, MEMBER, LENS UNIT, AND EQUIPMENT

(71) Applicant: CANON KABUSHIKI KAISHA, Tokyo (JP)

(72) Inventors: RYUNOSUKE ARAKAWA, Tochigi (JP); JUNNOSUKE NAKAMURA, Tochigi (JP)

(21) Appl. No.: 19/407,369

(22) Filed: Dec. 3, 2025

(30) Foreign Application Priority Data
Dec. 16, 2024 (JP) 2024-220356

(51) Int. Cl. C03B 11/12; B29D 11/00; C03B 11/08

(52) U.S. Cl. CPC C03B 11/122; B29D 11/00009; C03B 11/08

(57) ABSTRACT

A method for manufacturing a member, includes: a heating step of heating a preform to form a temperature distribution in the preform; and a molding step of pressing the preform, in which the temperature distribution has been formed, with a die to mold the member from the preform, wherein the preform has a first region and a second region outside the first region, and wherein the heating step forms the temperature distribution in which a temperature of the second region is lower than a temperature of the first region.

### BACKGROUND

### Field of the Technology

The present disclosure relates to a method for manufacturing a member, an apparatus for manufacturing a member, a preform, a member, a lens unit, and equipment.

### Description of the Related Art

In recent years, due to the increase in magnification and the miniaturization of optical instruments or devices, there has been a demand for highly precise and compact optical systems. Optical members made of glass are used in these optical systems, and the need to mold optical members with small outer diameters has increased with the miniaturization of products. In the molding of a small-diameter optical member, since the diameter of the molding die and the optical member are small, the amount of thermal deformation becomes small, and the molding die and the optical member may not be released. Therefore, a method for releasing a molding die and an optical member has been proposed.

Japanese Patent Laid-Open No. 2007-191359 discloses a method for releasing a molding die by projecting a release member from the contacting portion of the molding die and an optical member, bringing the release member into contact with the optical member and applying an external force when releasing the molding die and the optical member.

In addition, there is a method disclosed in Japanese Patent Laid-Open No. H05-147955 as a method that is different from a method for releasing a molding die by bringing a release member into contact with an optical member. Japanese Patent Laid-Open No. H05-147955 discloses a method for releasing an optical member from a molding die by forming a thin elastic portion on the outer peripheral portion of the molding die and applying an external force to the elastic portion to change the curvature of the outer peripheral portion.

However, in the method for releasing the molding die by applying an external force as described in Japanese Patent Laid-Open No. 2007-191359, the optical member may be damaged or cracked before being released from the molding die. In addition, in the method for deforming the thin elastic portion of the outer peripheral portion of the molding die as described in Japanese Patent Laid-Open No. H05-147955, there is a possibility that the molding apparatus becomes complicated and the cost of the optical member increases.

### SUMMARY

The present disclosure is directed to a method for manufacturing a member, an apparatus for manufacturing a member, a preform, a member, a lens unit, and equipment, capable of easily releasing a die from a member without causing damage or crack.

According to one aspect of the present disclosure, there is provided a method for manufacturing a member, the method including: a heating step of heating a preform to form a temperature distribution in the preform; and a molding step of pressing the preform, in which the temperature distribution has been formed, with a die to mold the member from the preform, wherein the preform has a first region and a second region outside the first region, and wherein the heating step forms the temperature distribution in which a temperature of the second region is lower than a temperature of the first region.

According to another aspect of the present disclosure, there is provided an apparatus for manufacturing a member, the apparatus including: a die; a heating unit configured to heat a preform to form a temperature distribution in the preform; and a drive system configured to press the preform, in which the temperature distribution has been formed, with the die to mold the member from the preform or to demold the member from the die, wherein the preform has a first region and a second region outside the first region, and wherein the heating unit forms the temperature distribution in which a temperature of the second region is lower than a temperature of the first region.

According to another aspect of the present disclosure, there is provided a preform for use in press molding, the preform including: a first region; and a second region outside the first region, wherein a film having an absorption rate of electromagnetic waves lower than that of the preform is formed in the second region.

According to another aspect of the present disclosure, there is provided a member including: a main body; and a film adhering to the main body, the film having an absorption rate of electromagnetic waves lower than that of the main body, wherein the main body has a first region and a second region outside the first region, and wherein a third region to which the film adheres and a fourth region where the main body is exposed are alternately arranged in the second region.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a molding apparatus according to a first embodiment of the present disclosure.

FIG. 2A is a cross-sectional view illustrating a state before press molding in a method for manufacturing an optical member according to the first embodiment of the present disclosure.

FIG. 2B is a cross-sectional view illustrating a state during the press molding in the method for manufacturing an optical member according to the first embodiment of the present disclosure.

FIG. 2C is a cross-sectional view illustrating a state after demolding in the method for manufacturing an optical member according to the first embodiment of the present disclosure.

FIG. 3A is a plan view illustrating an optical member after molding manufactured by the method for manufacturing an optical member according to the first embodiment of the present disclosure.

FIG. 3B is a cross-sectional view illustrating the optical member after the molding manufactured by the method for manufacturing an optical member according to the first embodiment of the present disclosure.

FIG. 4 is a cross-sectional view illustrating a molding die in a molding apparatus according to a modification 1 of the first embodiment of the present disclosure.

FIG. 5 is a cross-sectional view illustrating a molding die in a molding apparatus according to a modification 2 of the first embodiment of the present disclosure.

FIG. 6 is a cross-sectional view illustrating a molding die in a molding apparatus according to a modification 3 of the first embodiment of the present disclosure.

FIG. 7 is a cross-sectional view illustrating a molding die in a molding apparatus according to a modification 4 of the first embodiment of the present disclosure.

FIG. 8 is a cross-sectional view illustrating a molding die in a molding apparatus according to a modification 5 of the first embodiment of the present disclosure.

FIG. 9A is a cross-sectional view illustrating a molding die and a heater in a molding apparatus according to a second embodiment of the present disclosure.

FIG. 9B is a cross-sectional view illustrating the heater in the molding apparatus according to the second embodiment of the present disclosure.

FIG. 10A is a cross-sectional view illustrating a molding die and a heater in a molding apparatus according to a modification 1 of the second embodiment of the present disclosure.

FIG. 10B is a plan view illustrating the heater in the molding apparatus according to the modification 1 of the second embodiment of the present disclosure.

FIG. 11A is a cross-sectional view illustrating a molding die and a heater in a molding apparatus according to a modification 2 of the second embodiment of the present disclosure.

FIG. 11B is a plan view illustrating the heater in the molding apparatus according to the modification 2 of the second embodiment of the present disclosure.

FIG. 12A is a cross-sectional view illustrating a molding die and a heater in a molding apparatus according to a modification 3 of the second embodiment of the present disclosure.

FIG. 12B is a plan view illustrating the heater in the molding apparatus according to the modification 3 of the second embodiment of the present disclosure.

FIG. 13A is a schematic view illustrating an interchangeable lens according to a third embodiment of the present disclosure.

FIG. 13B is a cross-sectional view illustrating a lens unit in the interchangeable lens according to the third embodiment of the present disclosure.

FIG. 14A is a schematic view illustrating a camera according to the third embodiment of the present disclosure.

FIG. 14B is a cross-sectional view illustrating a lens unit in the camera according to the third embodiment of the present disclosure.

FIG. 15A is a schematic view illustrating an information terminal according to the third embodiment of the present disclosure.

FIG. 15B is a cross-sectional view illustrating a lens unit in a camera mounted on the information terminal according to the third embodiment of the present disclosure.

### DESCRIPTION OF THE EMBODIMENTS

### First Embodiment

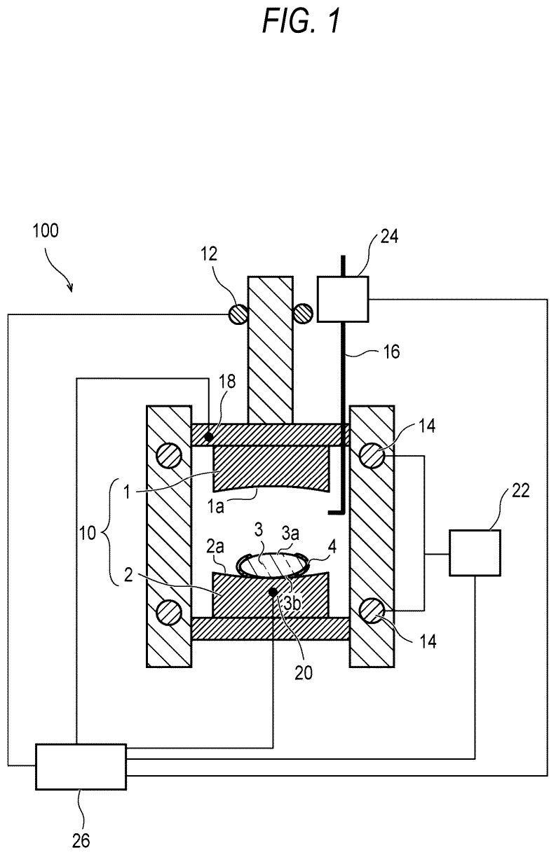

An apparatus for manufacturing an optical member, a method for manufacturing an optical member, a preform, and an optical member according to a first embodiment of the present disclosure will be described with reference to FIG. 1 to FIG. 8. In the present embodiment, a case where an optical member is manufactured will be described as an example of a member. Note that the following embodiments and examples are given by way of example, and the detailed configuration, for example, may be appropriately changed within the scope of the present disclosure. Further, in the figures referred to in the description of the following embodiments and examples, components or elements illustrated with the same reference numerals have the same functions, unless specifically provided otherwise. When a plurality of the same components or elements are arranged in the figures, reference numerals and explanations thereof may be omitted. For convenience of illustration and explanation, the shapes, sizes, arrangements, and the like of the components or elements illustrated in the figures may be schematically illustrated.

First, the configuration of an apparatus for manufacturing an optical member according to the present embodiment will be described with reference to FIG. 1. FIG. 1 is a schematic diagram illustrating an optical member molding apparatus 100 according to the present embodiment. Note that FIG. 1 illustrates a state of a molding die 10 before molding.

The optical member molding apparatus 100 according to the present embodiment is an apparatus for manufacturing an optical member by press molding. As illustrated in FIG. 1, the molding apparatus 100 according to the present embodiment includes a molding die 10, a drive system 12, a heater 14, and a gas inlet pipe 16. The apparatus 100 also includes a position sensor 18, a temperature sensor 20, a heater output control device 22, a flow rate control device 24, and a controller 26.

The molding die 10 is a die including, for example, a columnar upper die member 1 and, for example, a columnar lower die member 2. The upper die member 1 is arranged above the lower die member 2. The upper die member 1 has a molding surface 1a contacting with a preform 3 from the upper side, and the lower die member 2 has a molding surface 2a contacting with the preform 3 from the lower side. The molding surfaces 1a and 2a have shapes corresponding to the optical function surfaces of the optical member to be molded, respectively, and have shapes corresponding to one surface and the other surface of the optical member, which are opposite each other. The upper die member 1 and the lower die member 2 are arranged vertically so that the respective molding surfaces 1a and 2a face each other. The preform 3 to be molded into the optical member is arranged between the molding surfaces 1a and 2a which face each other. The molding die 10 is a metal die in which the upper die member 1 and the lower die member 2 are formed of metal, for example, but one or both of the upper die member 1 and the lower die member 2 may be formed of a material other than metal.

For example, in order to mold the optical member having a biconvex lens shape, the shapes of the molding surfaces 1a and 2a may be both concave. Further, the surface roughness of the molding surfaces 1a and 2a may be 30 nm or less at the maximum height Rmax. Further, a cemented carbide, for example, may be used as the material of the upper die member 1 and the lower die member 2. A film such as a diamond-like carbon (hereinafter referred to as “DLC”) film, for example, is formed on the molding surfaces 1a and 2a in view of securing wear resistance, smoothness, and the like. Note that a film such as a DLC film is not necessarily formed on the molding surfaces 1a and 2a. The shapes of the molding surfaces 1a and 2a are not particularly limited, and various shapes may be adopted according to the shape of the optical member to be molded as in modifications described later.

The drive system 12 presses the preform 3 having a temperature distribution formed in a heating step as described later by the molding die 10 in a molding step to mold the optical member from the preform 3 or releases the optical member from the molding die 10 in a demolding step. Specifically, the drive system 12 is, for example, a motor, and moves one or both of the upper die member 1 and the lower die member 2 in the vertical direction in press molding of the optical member. Thus, the drive system 12 makes the upper die member 1 and the lower die member 2 approach each other in the vertical direction to make the molding surface 1a and the molding surface 2a approach each other, and presses the preform 3 between the molding surface 1a and the molding surface 2a to mold the optical member. The drive system 12 also moves one or both of the upper die member 1 and the lower die member 2 in the vertical direction in demolding after molding of the optical member. Thus, the drive system 12 makes the upper die member 1 and the lower die member 2 separate each other in the vertical direction to make the molding surface 1a and the molding surface 2a separate each other to perform die opening. The position sensor 18 detects the vertical position of the upper die member 1 or the lower die member 2 driven by the drive system 12 and outputs position information relating to the position. The operation of the drive system 12 is controlled by the controller 26 based on the position information outputted from the position sensor 18.

The heater 14 is a heating unit that heats the molding die 10 including the upper die member 1 and the lower die member 2 and the preform 3 to a temperature suitable for press molding. The heater 14 is, for example, an infrared ray heater and heats the molding die 10 and the preform 3 by irradiating energy with electromagnetic waves such as infrared rays or the like. As the heater 14, a heater capable of heating 1000° C. or higher under an inert atmosphere such as N₂ gas may be used. The temperature sensor 20 is, for example, provided in or on the molding die 10, detects the temperature of the molding die 10 and outputs temperature information relating to the temperature of the molding die 10. The heater output control device 22 controls the output of the heater 14. The operation of the heater output control device 22 is controlled by the controller 26 based on the temperature information outputted from the temperature sensor 20.

The gas inlet pipe 16 is a cooling unit that cools the molding die 10 in order to take out the molded optical member from the molding die 10. The gas inlet pipe 16 is constituted so as to spray cooling gas such as N₂ gas to the molding die 10 including the upper die member 1 and the lower die member 2 and the heater 14, which are targets to be cooled. The flow rate control device 24 controls the flow rate of the cooling gas in the gas inlet pipe 16. The operation of the flow rate control device 24 is controlled by the controller 26 based on the temperature information outputted from a temperature sensor 20. Note that the cooling unit that cools the molding die 10 is not limited to the gas inlet pipe 16, and may cool the molding die 10 with another cooling mechanism.

The controller 26 is an information processing apparatus that functions as a control unit that manages and controls each part of the molding apparatus 100. The controller 26 includes a processor (not illustrated) that executes various processes such as calculation, control, determination, and the like. Furthermore, the controller 26 also includes a storage (not illustrated) that stores various control programs executed by the processor, a database referenced to by the processor, and the like. Furthermore, the controller 26 also includes a memory (not illustrated) that temporarily stores data being processed by the processor, input data, and the like. Note that the controller 26 is not particularly limited, but may be configured by a general-purpose computer device such as a personal computer, or may be configured by a computer device dedicated to the molding apparatus 100. Note also that each function of the controller 26 may be realized by a single computer device or by a plurality of computer devices.

The controller 26 controls the movement of one or both of the upper die member 1 and the lower die member 2 in the vertical direction by controlling the operation of the drive system 12 based on the position information outputted from the position sensor 18. Furthermore, the controller 26 controls the temperature of the molding die 10 by controlling the operation of the heater output control device 22 based on the temperature information outputted from the temperature sensor 20 to control the temperature of the heater 14. The controller 26 controls the temperature of the heater 14 to control the temperature of the molding die 10 and the preform 3 at the time of press molding to a desired temperature. Furthermore, the controller 26 controls the temperature of the molding die 10 by controlling the operation of the flow rate control device 24 based on the temperature information outputted from the temperature sensor 20 to control the flow rate of the cooling gas in the gas inlet pipe 16. The controller 26 controls the flow rate of the cooling gas to control the temperature of the molding die 10 and the optical member at the time of cooling after press molding to a desired temperature.

The preform 3 is a molding material such as an optical glass that can be molded into an optical member. The optical glass used as the material of the preform 3 is, for example, borosilicate-based glass, lanthanum-based glass, fluorophosphate-based glass, or the like. Note that the preform 3 is not limited to an optical glass but may be made of a resin such as a thermoplastic resin or may be made of a composite material of glass and resin. The shape of the preform 3 is not particularly limited, but the shape of the preform 3 is a disk shape having two surfaces 3a and 3b opposite each other, where both of the surfaces 3a and 3b are outwardly convex. During press molding, the preform 3 is placed on the molding surface 2a so that one surface 3a faces the molding surface 1a of the upper die member 1 and the other surface 3b faces the molding surface 2a of the lower die member 2.

A film 4 having an absorption rate of electromagnetic waves lower than that of the preform 3 is partially formed on the surface of the preform 3. The electromagnetic waves mentioned here are electromagnetic waves such as infrared rays emitted by the heater 14 that heats the molding die 10 and the preform 3. The film 4 preferably has an absorption rate of electromagnetic waves 50% or more lower than that of the preform 3 with respect to a peak wavelength of the electromagnetic waves.

Specifically, the film 4 is formed on the surface of an outer peripheral region of the preform 3 having a central region and the outer peripheral region outside the central region, that is, on the outer peripheral regions of surfaces 3a and 3b, which constitute the surface of the preform 3. The film 4 is also formed on the surface of the side portion of the preform 3 between the outer peripheral region of the surface 3a and the outer peripheral region of the surface 3b. The outer peripheral region of the preform 3 is a peripheral region having a prescribed width outside the central region of the preform 3. The central region of the preform 3 is surrounded by the outer peripheral region of the preform 3. The outer peripheral region of the preform 3 is preferably a region corresponding to a region outside the optical effective diameter of an optical member 5 formed from the preform 3. Here, the optical effective diameter means a diameter of a surface having an optical function of the optical member 5. Specifically, when the preform 3 has a planar shape such as a circular shape or the like, the outer peripheral region is preferably a region outside the central region occupying 90% of the outer diameter of the preform 3.

The film 4 is formed by a film forming method such as a sputtering, a vapor deposition, a chemical vapor deposition (CVD), a wet coating, a brush coating or the like, for example, although the film forming method is not particularly limited to these methods. The film 4 may be previously formed on the preform 3 by using these film forming methods in a film forming step prior to the execution of the method for manufacturing an optical member. The film 4 may also be formed on the preform 3 by using these film forming methods in a film forming step as one step in the method for manufacturing an optical member. The film 4 may be formed continuously, intermittently or partially on the outer peripheral region of the preform 3. The thickness of the film 4 is not particularly limited but is, for example, several tens of nm or more and 100 nm or less.

Further, it is preferable that the film 4 is a film that does not easily adhere to the films such as DLC films formed on the molding surfaces 1a and 2a of the upper die member 1 and the lower die member 2. The film 4 is made of a material including, for example, an oxide or carbon. Specifically, the film 4 may be exemplified by a film made of silicon dioxide (referred to as “SiO₂” hereafter), zirconia (referred to as “ZrO₂” hereafter), hydrocarbon (referred to as “CH” hereafter), DLC, tin oxide (referred to as “SnO₂” hereafter), alumina (referred to as “Al₂O₃” hereafter), or the like. In the present embodiment, a temperature distribution is formed within the preform 3 in a heating step due to the formation of the film 4, as described later.

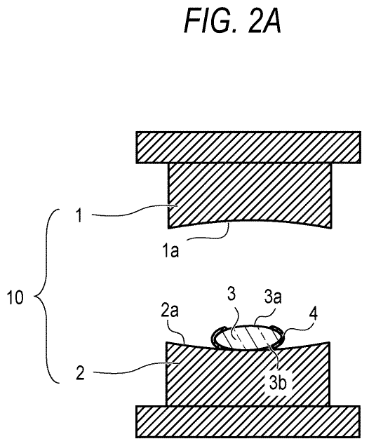

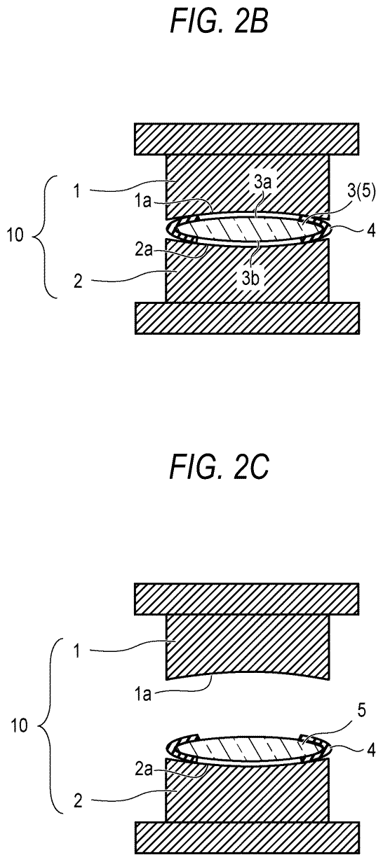

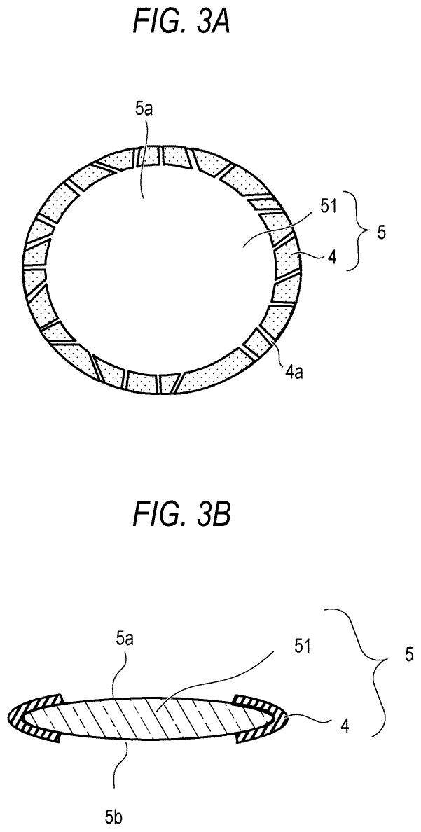

Next, a method for manufacturing an optical member using the molding apparatus 100 according to the present embodiment will be described with reference to FIG. 2A to FIG. 3B. FIG. 2A to FIG. 2C are cross-sectional views illustrating cross sections of the molding die 10, the preform 3 or the optical member 5 and the film 4 in the method for manufacturing an optical member according to the present embodiment. FIG. 2A illustrates a state before press molding, FIG. 2B illustrates a state during press molding, and FIG. 2C illustrates a state after press molding. FIG. 3A is a plan view illustrating the optical member 5 after molding. FIG. 3B is a cross-sectional view illustrating the optical member 5 after molding.

The method for manufacturing an optical member using the molding apparatus 100 according to the present embodiment includes a heating step, a press molding step, a cooling step, and a demolding step, which are executed sequentially. Note that the temperature, the press load, the shape of the molding die 10, and the like to be selected in a series of the molding processes may be appropriately set according to the kind of material such as optical glass constituting the preform 3, the shape of the optical member, and the like.

Before starting the heating step, the molding die 10 is in an opened state, and a predetermined interval is provided between the upper die member 1 and the lower die member 2. First, in the heating step, the controller 26 controls the output of a heater 14 by the heater output control device 22, and heats the molding die 10 by the heater 14 so that the temperature of the molding die 10 becomes a first temperature. When the temperature of the molding die 10 becomes the first temperature, the preform 3 is arranged on the center of the molding surface 2a of the lower die member 2, and the preform 3 is arranged between the molding surface 1a of the upper die member 1 and the molding surface 2a of the lower die member 2 as illustrated in FIG. 2A. Thus, the preform 3 is arranged in the molding die 10. The film 4 may be formed on the preform 3 in advance in a film forming step prior to the implementation of the method for manufacturing the optical member, or the film 4 may be formed by a film forming step as one step in the method for manufacturing an optical member, as described above.

After the preform 3 is arranged, further in the heating step, the controller 26 controls the output of the heater 14 via the heater output control device 22, and heats the molding die 10 by the heater 14 so that the temperature of the molding die 10 becomes a second temperature higher than the first temperature. Thus, the preform 3 arranged in the molding die 10 is heated, and the preform 3 is softened until the viscosity of the preform 3 becomes a state suitable for press molding.

Here, as described above, the film 4 having an absorption rate of electromagnetic waves lower than the absorption rate of electromagnetic waves of the preform 3 is formed on the surface of the outer peripheral region of the preform 3. Therefore, in the preform 3, the absorption rate of electromagnetic waves varies between the outer peripheral region where the film 4 is formed and the central region which is a region inside the outer peripheral region. Since the absorption rate of electromagnetic waves of the film 4 formed on the outer peripheral region is lower than the absorption rate of electromagnetic waves of the preform 3, the central region of the preform 3 becomes higher temperature than the outer peripheral region of the preform 3 when the preform 3 is heated by radiation. Thus, a temperature distribution is formed in the preform 3 by the heating step due to the formation of the film 4. In the temperature distribution, it is preferable that the temperatures of the central region and the outer peripheral region of the preform 3 are equal to or higher than the glass transition temperature of the preform 3 from the viewpoint of moldability. Furthermore, in the temperature distribution, it is preferable that the temperature of the outer peripheral region of the preform 3 is lower than that of the central region of the preform 3 by 10° C. or more from the viewpoint of securing better demoldability.

Next, in the press molding step, the controller 26 controls the operation of the drive system 12 to move the upper die member 1 positioned above the preform 3 downward, and presses the softened preform 3 by applying a press load to the preform 3. Here, the temperature distribution is formed in the preform 3 as described above. Thus, the controller 26 transfers the shapes of the molding surfaces 1a and 2a of the upper die member 1 and the lower die member 2 to the preform 3 to obtain the optical member 5 having a desired shape. Note that the controller 26 proceeds to the next cooling step while maintaining the pressing state for pressing the optical member 5 for a certain period even after the press molding is completed.

Next, in the cooling step, the controller 26 controls the flow rate of the cooling gas blown out from the gas inlet pipe 16 via the flow rate control device 24 to cool the molding die 10 and the optical member 5 to a desired temperature. The controller 26 proceeds to a demolding step when the temperature of the molding die 10 becomes a third temperature lower than the second temperature.

Next, in the demolding step, the controller 26 moves the upper die member 1 positioned on the optical member 5 formed from the preform 3 upward to unload the press load applied to the optical member 5 as illustrated in FIG. 2C. When the press load is unloaded, the optical member 5, which has been compressed by the press load, deforms, and the optical member 5 is demolded from the molding surfaces 1a and 2a of the upper die member 1 and the lower die member 2. After the demolding, the optical member 5 is taken out from the molding die 10.

Thus, the optical member 5 is manufactured by press molding. Note that the above manufacturing method is one example, and various modifications are possible. For example, although the case in which the upper die member 1 is moved downward and upward is described above, the method is not limited to this. For example, it is possible that by moving the lower die member 2 upward and downward together with the upper die member 1 or instead of the upper die member 1, the preform 3 is pressed in the molding step and the optical member 5 is demolded from the molding die 10 in the demolding step.

As illustrated in FIG. 3A and FIG. 3B, there is a case in which the film 4 remains and adheres to the optical member 5 after being taken out from the molding die 10. In this case, the optical member 5 has a main body 51 formed of the molded preform 3 and the film 4 partially adhered to the surface of the main body 51. The main body 51 has a central region corresponding to the central region of the preform 3 and an outer peripheral region corresponding to the outer peripheral region of the preform 3. The film 4 is formed on the outer peripheral region of the main body 51. Specifically, the main body 51 has surfaces 5a and 5b corresponding to surfaces 3a and 3b of the preform 3. The film 4 remains and adheres to the outer peripheral regions of the surfaces 5a and 5b of the main body 51. The film 4 has an absorption rate of electromagnetic waves lower than that of the main body 51 formed of the preform 3. The outer peripheral region of the main body 51 to which the film 4 adheres is preferably a region outside the optical effective diameter of the optical member 5. Specifically, when the main body 51 has a planar shape such as a circle, the outer peripheral region is preferably a region outside the central region occupying 90% of the outer diameter of the main body 51.

The film 4 adhered to the outer peripheral regions of the surfaces 5a and 5b has cracks 4a such as cracks exposing the surfaces 5a and 5b. The crack 4a is generated so as to divide the film 4 in the circumferential direction of the optical member 5. Thus, a region where the film 4 is adhered and a region where the surfaces 5a and 5b of the main body 51 are exposed from the crack 4a are alternately arranged in the outer peripheral region of the main body 51.

Note that, when the film 4 is adhered to the optical member 5, the adhered film 4 may be removed or left as adhered. The film 4 may be removed from the optical member 5 by etching or the like. In addition, the film 4 may disappear without remaining in the optical member 5 after molding due to heat or the like when molding the optical member 5 from the preform 3 depending on the material.

As described above, in the present embodiment, the film 4 having an absorption rate of electromagnetic waves lower than the absorption rate of electromagnetic waves of the preform 3 is formed on the outer peripheral region of the preform 3. Consequently, in the present embodiment, the temperature of the outer peripheral region of the preform 3 in which the film 4 is formed in advance is lower than that of the central region of the preform 3 in the heating step. The viscosity of the material of the preform 3 such as glass or the like becomes higher as the temperature becomes lower. Therefore, the viscosity of the material of the outer peripheral region of the preform 3 becomes higher than that of the material of the central region of the preform 3 due to the temperature distribution formed in the preform 3 by the heating step in the state in which the film 4 is formed. Thus, when the preform 3 is press-molded in the molding step in a state where the viscosity of the material is higher in the outer peripheral region than in the central region, it becomes difficult for the material to bite into the molding surfaces 1a and 2a of the molding die 10 in the outer peripheral region of the preform 3. Therefore, the true contact area between the outer peripheral region of the preform 3 and the molding surfaces 1a and 2a of the molding die 10 is reduced, and the adhesive force between them is reduced. Since the adhesive force between the outer peripheral region of the optical member 5 molded from the preform 3 and the molding die 10 can be reduced in this way, demolding occurs from the outer peripheral region of the optical member 5 in the cooling step or the demolding step. When the demolding occurs in the outer peripheral region of the optical member 5, stress becomes concentrated in the outermost portion of the optical member 5 where the molding die is not released, and demolding occurs continuously, and demolding can be made to the center of the optical member 5.

On the other hand, in the method of releasing the optical element by applying an external force to the optical member described in Japanese Patent Laid-Open No. 2007-191359, when the adhesion between the optical element and the die is strong, stress is concentrated in the place where the optical member and the releasing member come into contact with each other, and the optical member may be damaged or cracked before releasing the optical element from the molding die. In particular, since the strength of optical members having small diameters or thin thicknesses are low, the method described in Japanese Patent Laid-Open No. 2007-191359 tends to cause cracking due to concentration of stress in the optical elements having small diameters or thin thicknesses.

Furthermore, in the method described in Japanese Patent Laid-Open No. H05-147955 for deforming the thin elastic portion of the outer peripheral portion of the die to release the die, a pressurizing member that deforms the elastic portion is required, and a drive system that drives the pressurizing member must be provided separately in the apparatus. Therefore, in the method described in Japanese Patent Laid-Open No. H05-147955, the molding apparatus may become complicated, and the cost of the optical member may be increased.

As described above, according to the present embodiment, the adhesive force between the preform 3 and the molding surfaces 1a and 2a of the molding die 10 is reduced in the outer peripheral region of the preform 3, which makes it easy to start the demolding from the outer peripheral region of the optical member 5 molded from the preform 3. Therefore, according to the present embodiment, the demolding between the molding die 10 and the optical member 5 can be easily realized without causing scratches or cracks even when the optical member 5 has a small diameter or a thin wall with low strength.

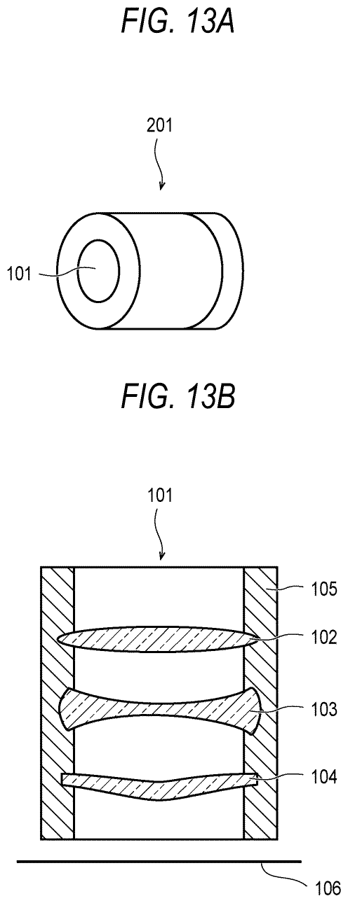

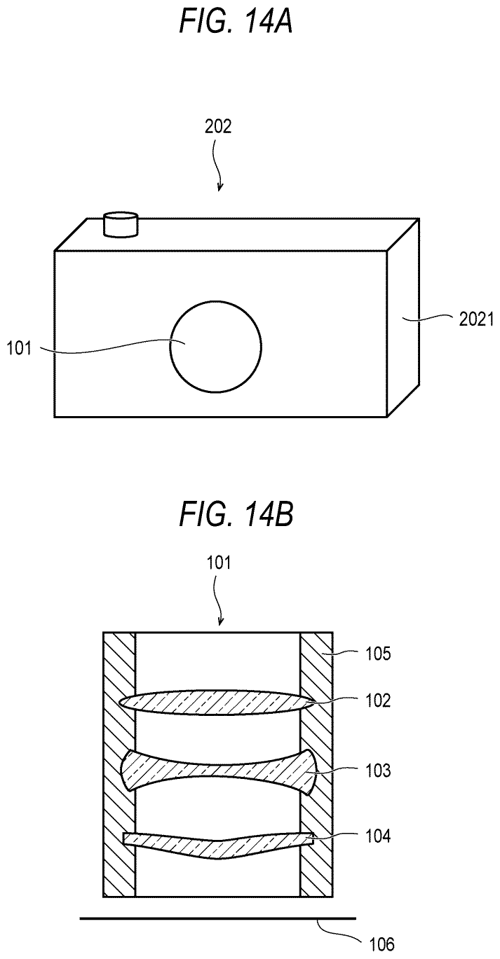

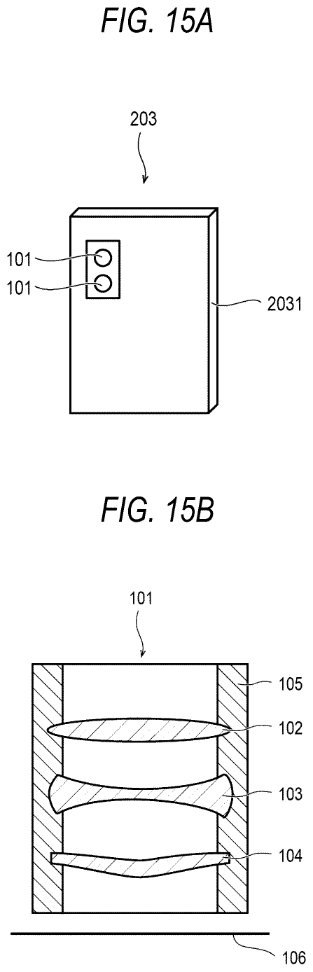

The optical member 5 thus manufactured may be used in a lens unit 101 such as an interchangeable lens 201 illustrated in FIG. 13A and FIG. 13B, a camera 202 illustrated in FIG. 14A and FIG. 14B, a camera mounted on an information terminal 203 such as a smartphone or the like illustrated in FIG. 15A and FIG. 15B, or the like. These are described in a third embodiment.

### <Modification 1 of First Embodiment>

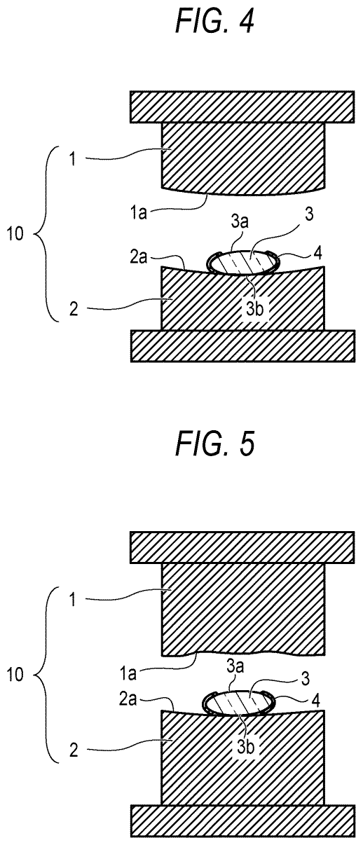

A modification 1 of the first embodiment will be described with reference to FIG. 4. FIG. 4 is a cross-sectional view illustrating a molding die 10 in a molding apparatus 100 according to the present modification.

The configuration of the molding apparatus 100 according to the present modification is the same as the configuration of the molding apparatus 100 according to the first embodiment except for the shape of the molding die 10. In the present modification, the shape of the molding die 10 is changed in order to change the shape of the optical member 5 to be molded into a convex meniscus shape. That is, in the present modification, the molding surface 1a of the upper die member 1 is formed in a convex shape and the molding surface 2a of the lower die member 2 is formed in a concave shape, as illustrated in FIG. 4, in the molding die 10. Further, the shapes of the molding surfaces 1a and 2a are changed so that the thickness of the central region is thicker than the thickness of the outer peripheral region in the optical member 5 to be molded. The optical member 5 having a convex meniscus shape can also be molded by using the molding die 10 having the shape thus changed.

### <Modification 2 of First Embodiment>

A modification 2 of the first embodiment will be described with reference to FIG. 5. FIG. 5 is a cross-sectional view illustrating a molding die 10 in a molding apparatus 100 according to the present modification.

The configuration of the molding apparatus 100 according to the present modification is the same as the configuration of the molding apparatus 100 according to the first embodiment except for the shape of the molding die 10. In the present modification, the shape of the molding die 10 is changed in order to change the shape of the optical member 5 to be molded into a shape having a plurality of inflection points. That is, in the present modification, the shape of the molding die 10 is changed into a shape having a plurality of inflection points corresponding to a plurality of inflection points that the optical member 5 to be molded should have, as illustrated in FIG. 5. The optical member 5 having a plurality of inflection points can also be molded by using the molding die 10 having the shape thus changed.

### <Modification 3 of First Embodiment>

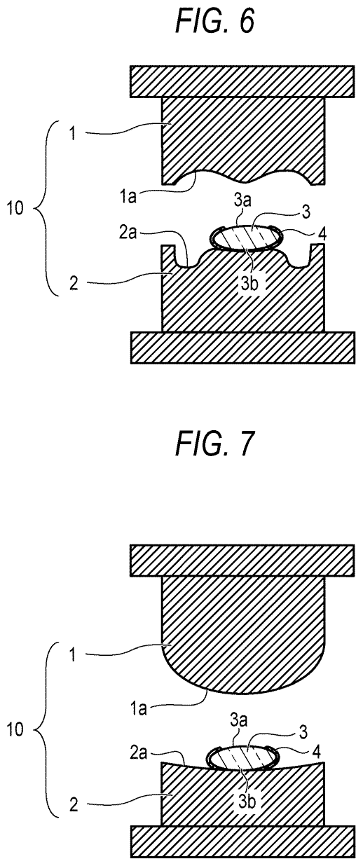

A modification 3 of the first embodiment will be described with reference to FIG. 6. FIG. 6 is a cross-sectional view illustrating a molding die 10 in a molding apparatus 100 according to the present modification.

The configuration of the molding apparatus 100 according to the present modification is the same as the configuration of the molding apparatus 100 according to the first embodiment except for the shape of the molding die 10. In the present modification, the shape of the molding die 10 is changed because the shape of the optical member 5 to be molded is changed to a shape having a plurality of inflection points different from that of the modification 2. That is, in the present modification, the shape of the molding die 10 is changed to a shape having a plurality of inflection points corresponding to a plurality of inflection points different from that of the modification 2 that the optical member 5 to be molded should have, as illustrated in FIG. 6. The optical member 5 having a plurality of inflection points different from that of the modification 2 can also be molded by using the molding die 10 having the shape thus changed.

### <Modification 4 of First Embodiment>

A modification 4 of the first embodiment will be described with reference to FIG. 7. FIG. 7 is a cross-sectional view illustrating a molding die 10 in a molding apparatus 100 according to the present modification.

The configuration of the molding apparatus 100 according to the present modification is the same as the configuration of the molding apparatus 100 according to the first embodiment except for the shape of the molding die 10. In the present modification, in order to change the shape of the optical member 5 to be molded into the shape of a concave meniscus, the shape of the molding die 10 is changed. That is, in the present modification, the molding surface 1a of the upper die member 1 is formed into a convex shape, and the molding surface 2a of the lower die member 2 is formed into a concave shape, as illustrated in FIG. 7. Further, the shapes of the molding surfaces 1a and 2a are changed so that the thickness of the central region is thinner than the thickness of the outer peripheral region in the optical member 5 to be molded. The optical member 5 having a concave meniscus shape can also be molded by using the molding die 10 having the shape thus changed.

### <Modification 5 of First Embodiment>

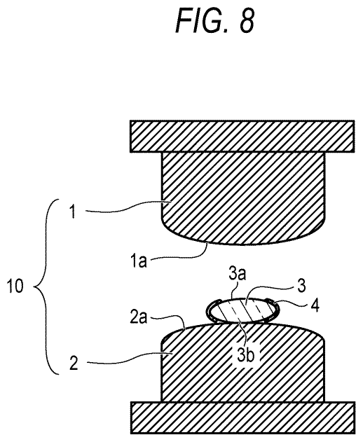

A modification 5 of the first embodiment will be described with reference to FIG. 8. FIG. 8 is a cross-sectional view illustrating a molding die 10 in a molding apparatus 100 according to the present modification.

The configuration of the molding apparatus 100 according to the present modification is the same as the configuration of the molding apparatus 100 according to the first embodiment except for the shape of the molding die 10. In the present modification, in order to change the shape of the optical member 5 to be molded into a biconcave shape, the shape of the molding die 10 is changed. That is, in the present modification, the molding surfaces 1a and 2a of the upper die member 1 and the lower die member 2 are changed into convex shapes, as illustrated in FIG. 8. The optical member 5 having the biconcave shape can also be molded by using the molding die 10 having the shape thus changed.

### Example 1-1

In Example 1-1, the optical member 5 having a biconvex shape was molded by the method for manufacturing an optical member according to the first embodiment. The dimensions of the molded optical member 5 were: the outer diameter φ10.0 mm; the total height 2.9 mm; the center thickness 2.9 mm; the end thickness 1.4 mm; the optical effective diameter φ9.3 mm of the upper surface 5a; and the optical effective diameter q 8.9 mm of the lower surface 5b. The preform 3 made of optical glass for glass molding having a glass transition temperature of 500° C. was used. A SiO₂ film was formed as the film 4 on the preform 3. An infrared heater was used as the heater 14 used when heating the molding die 10 and the preform 3.

After the molding die 10 was heated to 450° C. as the first temperature in the heating step, the preform 3 was arranged in the molding die 10. Thereafter, the preform 3 was heated to 560° C. as the second temperature higher than the first temperature, and the preform 3 was softened until the viscosity of the preform 3 became a state suitable for press molding. Since the SiO₂ film was formed as the film 4 on the outer peripheral region of the preform 3, the temperature of the outer peripheral region was lower than that of the central region in the preform 3, with a temperature difference of 10.2° C. The points for measuring the temperatures of the central region and the outer peripheral region of the preform 3 were the center point of the upper side surface 3a of the preform 3 arranged in the molding die 10 and the outermost peripheral point of the upper side surface 3a of the preform 3, respectively. For measuring the temperature of the preform 3, an infrared camera (high-performance thermography FLIR T860 for research and development manufactured by Flir Systems) was used.

In the next press molding step, the molding die 10 was brought into contact with the preform 3 by a press load of 4000 N to press the preform 3, and the optical member 5 having a biconvex shape was molded from the preform 3.

In the cooling step and the demolding step, the press load applied to the molding die 10 was unloaded when the temperature of the molding die 10 became 450° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-1

In Comparative Example 1-1, the same molding die 10 as in Example 1-1 was used, and the optical member 5 was molded in the same manner as in Example 1-1 from the same preform 3 as in Example 1-1 except that the film 4 was not formed. The press load was unloaded at the third temperature after the heating step, the molding step and the cooling step described above, but the demolding of the optical member 5 did not occur.

### Example 1-2

In Example 1-2, the optical member 5 having a biconvex shape was molded by the method for manufacturing an optical member according to the first embodiment. The dimensions of the molded optical member 5 were: the outer diameter φ15.0 mm; the total height 4.3 mm; the center thickness 4.3 mm; the end thickness 2.2 mm; and the optical effective diameter φ14.1 mm of the upper surface 5a; and the optical effective diameter φ13.0 mm of the lower surface 5b. The preform 3 made of optical glass for glass molding having a glass transition temperature of 512° C. was used. A ZrO₂ film was formed as the film 4 on the preform 3. An infrared heater was used as the heater 14 used when heating the molding die 10 and the preform 3.

After the molding die 10 was heated to 460° C. as the first temperature in the heating step, the preform 3 was arranged in the molding die 10. Thereafter, the preform 3 was heated to 570° C. as the second temperature higher than the first temperature, and the preform 3 was softened until the viscosity of the preform 3 became a state suitable for press molding. Since the ZrO₂ film was formed as the film 4 on the outer peripheral region of the preform 3, the temperature of the outer peripheral region was lower than that of the central region in the preform 3, with a temperature difference of 11.0° C.

In the next press molding step, the molding die 10 was brought into contact with the preform 3 by a press load of 4000 N to press the preform 3, and the optical member 5 having a biconvex shape was molded from the preform 3.

In the cooling step and the demolding step, the press load applied to the molding die 10 was unloaded when the temperature of the molding die 10 became 460° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-2

In Comparative Example 1-2, the same molding die 10 as in Example 1-2 was used, and the optical member 5 was molded in the same manner as in Example 1-2 from the same preform 3 as in Example 1-2 except that the film 4 was not formed. The press load was unloaded at the third temperature after the heating step, the molding step and the cooling step described above, the demolding of the optical member 5 did not occur.

### Example 1-3

In Example 1-3, the optical member 5 having a biconvex shape was molded by the method for manufacturing an optical member according to the first embodiment. The dimensions of the molded optical member 5 were: the outer diameter φ20.0 mm; the total height 5.8 mm; the center thickness 5.8 mm; the end thickness 2.8 mm; the optical effective diameter φ18.7 mm of the upper surface 5a; and the optical effective diameter 17.8 mm of the lower surface 5b. The preform 3 made of optical glass for glass molding having a glass transition temperature of 512° C. was used. A CH film was formed as the film 4 on the preform 3. An infrared heater was used as the heater 14 used when heating the molding die 10 and the preform 3.

After the molding die 10 was heated to 460° C. as the first temperature in the heating step, the preform 3 was arranged in the molding die 10. Thereafter, the preform 3 was heated to 570° C. as the second temperature higher than the first temperature, and the preform 3 was softened until the viscosity of the preform 3 became a state suitable for press molding. Since the CH film was formed as the film 4 on the outer peripheral region of the preform 3, the temperature of the outer peripheral region was lower than that of the central region in the preform 3, with a temperature difference of 10.5° C.

In the next press molding step, the molding die 10 was brought into contact with the preform 3 by a press load of 4000 N to press the preform 3, and the optical member 5 having a biconvex shape was molded from the preform 3.

In the cooling step and the demolding step, the press load applied to the molding die 10 was unloaded when the temperature of the molding die 10 became 460° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-3

In Comparative Example 1-3, the same molding die 10 as in Example 1-3 was used, and the optical member 5 was molded in the same manner as in Example 1-3 from the same preform 3 as in Example 1-3 except that the film 4 was not formed. The press load was unloaded at the third temperature after the heating step, the molding step and the cooling step described above, but the demolding of the optical member 5 did not occur.

### Example 1-4

In Example 1-4, the optical member 5 having a convex meniscus shape was molded by the method for manufacturing an optical member according to the modification 1 of the first embodiment. The dimension of the molded optical member 5 were: the outer diameter φ9.8 mm; the total height 1.4 mm; the center thickness 1.4 mm; the end thickness 0.7 mm; the optical effective diameter φ8.2 mm of the upper surface 5a; and the optical effective diameter φ8.6 mm of the lower surface 5b. The preform 3 made of optical glass for glass molding having a glass transition temperature of 458° C. was used. A DLC film was formed as the film 4 on the preform 3. An infrared heater was used as the heater 14 used when heating the molding die 10 and the preform 3.

After the molding die 10 was heated to 400° C. as the first temperature in the heating step, the preform 3 was arranged in the molding die 10. Thereafter, the preform 3 was heated to 510° C. as the second temperature higher than the first temperature, and the preform 3 was softened until the viscosity of the preform 3 became a state suitable for press molding. Since the DLC film was formed as the film 4 on the outer peripheral region of the preform 3, the temperature of the outer peripheral region was lower than the that of the central region in the preform 3, with a temperature difference of 15.1° C.

In the next press molding step, the molding die 10 was brought into contact with the preform 3 by a press load of 4000 N to press the preform 3, and the optical member 5 having a convex meniscus shape was molded from the preform 3.

In the cooling step and the demolding step, the press load applied to the molding die 10 was unloaded when the temperature of the molding die 10 became 400° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-4

In Comparative Example 1-4, the same molding die 10 as in Example 1-4 was used, and the optical member 5 was molded in the same manner as in Example 1-4 from the same preform 3 as in Example 1-4 except that the film 4 was not formed. The press load was unloaded at the third temperature after the heating step, the molding step and the cooling step described above, but the demolding of the optical member 5 did not occur.

### Example 1-5

In Example 1-5, the optical member 5 having a convex meniscus shape was molded by the method for manufacturing an optical member according to the modification 1 of the first embodiment. The dimensions of the molded optical member 5 were: the outer diameter φ14.7 mm; the total height 2.0 mm; the center thickness 2.0 mm; the end thickness 1.0 mm; the optical effective diameter φ12.3 mm of the upper surface 5a; and the optical effective diameter φ13.0 mm of the lower surface 5b. The preform 3 made of optical glass for glass molding having a glass transition temperature of 512° C. was used. A DLC film was formed as the film 4 on the preform 3. An infrared heater was used as the heater 14 used when heating the molding die 10 and the preform 3.

After the molding die 10 was heated to 460° C. as the first temperature in the heating step, the preform 3 was arranged in the molding die 10. Thereafter, the preform 3 was heated to 570° C. as the second temperature higher than the first temperature, and the preform 3 was softened until the viscosity of the preform 3 became a state suitable for press molding. Since the DLC film was formed as the film 4 on the outer peripheral region of the preform 3, the temperature of the outer peripheral region was lower than that of the central region in the preform 3, with a temperature difference of 10.3° C.

In the next press molding step, the molding die 10 was brought into contact with the preform 3 by a press load of 4000 N to press the preform 3, and the optical member 5 having a convex meniscus shape was molded from the preform 3.

In the cooling step and the demolding step, the press load applied to the molding die 10 was unloaded when the temperature of the molding die 10 became 460° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-5

In Comparative Example 1-5, the same molding die 10 as in Example 1-5 was used, and the optical member 5 was molded in the same manner as in Example 1-5 from the same preform 3 as in Example 1-5 except that the film 4 was not formed. The press load was unloaded at the third temperature after the heating step, the molding step and the cooling step described above, but the demolding of the optical member 5 did not occur.

### Example 1-6

In Example 1-6, the optical member having a convex meniscus shape was molded by the method for manufacturing an optical member according to the modification 1 of the first embodiment. The dimensions of the molded optical member 5 were: the outer diameter φ19.5 mm; the total height 2.7 mm; the center thickness 2.7 mm; the end thickness 1.4 mm; the optical effective diameter φ 16.4 mm of the upper surface 5a; and the optical effective diameter φ17.3 mm of the lower surface 5b. The preform 3 made of optical glass for glass molding having a glass transition temperature of 512° C. was used. An Al₂O₃ film was formed as the film 4 on the preform 3. An infrared heater was used as the heater 14 used when heating the molding die 10 and the preform 3.

After the molding die 10 was heated to 460° C. as the first temperature in the heating step, the preform 3 was arranged in the molding die 10. Thereafter, the preform 3 was heated to 570° C. as the second temperature higher than the first temperature, and the preform 3 was softened until the viscosity of the preform 3 became a state suitable for press molding. Since the Al₂O₃ film was formed as the film 4 on the outer peripheral region of the preform 3, the temperature of the outer peripheral region was lower than that of the central region in the preform 3, with a temperature difference of 11.4° C.

In the next press molding step, the molding die 10 was brought into contact with the preform 3 by a press load of 4000 N to press the preform 3, and the optical member 5 having a convex meniscus shape was molded from the preform 3.

In the cooling step and the demolding step, the press load applied to the molding die 10 was unloaded when the temperature of the molding die 10 became 460° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-6

In Comparative Example 1-6, the same molding die 10 as in Example 1-6 was used, and the optical member 5 was molded in the same manner as in Example 1-6 from the same preform 3 as in Example 1-6 except that the film 4 was not formed. The press load was unloaded at the third temperature after the heating step, the molding step and the cooling step described above, but the demolding of the optical member 5 did not occur.

### Example 1-7

In Example 1-7, the optical member 5 having a plurality of inflection points was molded by the method for manufacturing an optical member according to the modification 2 of the first embodiment. The dimensions of the molded optical member 5 were: the outer diameter φ9.7 mm; the total height 1.4 mm; the center thickness 1.4 mm; the end thickness 0.6 mm; the optical effective diameter φ9.3 mm of the upper surface 5a; and the optical effective diameter φ9.1 mm of the lower surface 5b. The preform 3 made of optical glass for glass molding having a glass transition temperature of 500° C. was used. A ZrO₂ film was formed as the film 4 on the preform 3. An infrared heater was used as the heater 14 used when heating the molding die 10 and the preform 3.

After the molding die 10 was heated to 450° C. as the first temperature in the heating step, the preform 3 was arranged in the molding die 10. Thereafter, the preform 3 was heated to 560° C. as the second temperature higher than the first temperature, and the preform 3 was softened until the viscosity of the preform 3 became a state suitable for press molding. Since the ZrO₂ film was formed as the film 4 on the outer peripheral region of the preform 3, the temperature of the outer peripheral region was lower than that of the central region in the preform 3, with a temperature difference of 10.6° C.

In the next press molding step, the molding die 10 was brought into contact with the preform 3 by a press load of 4000 N to press the preform 3, and the optical member 5 having a plurality of inflection points was molded from the preform 3.

In the cooling step and the demolding step, the press load applied to the molding die 10 was unloaded when the temperature of the molding die 10 became 450° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-7

In Comparative Example 1-7, the same molding die 10 as in Example 1-7 was used, and the optical member 5 was molded in the same manner as in Example 1-7 from the same preform 3 as in Example 1-7 except that the film 4 was not formed. The press load was unloaded at the third temperature after the heating step, the molding step and the cooling step described above, but the demolding of the optical member 5 did not occur.

### Example 1-8

In Example 1-8, the optical member 5 having a plurality of inflection points was molded by the method for manufacturing an optical member according to the modification 2 of the first embodiment. The dimensions of the molded optical member 5 were: the outer diameter φ14.6 mm; the total height 2.1 mm; the center thickness of 2.1 mm; the end thickness of 0.9 mm; the optical effective diameter φ14.0 mm of the upper surface 5a; and the optical effective diameter φ13.7 mm of the lower surface 5b. The preform 3 made of optical glass for glass molding having a glass transition temperature of 458° C. was used. A SiO₂ film was formed as the film 4 on the preform 3. An infrared heater was used as the heater 14 used when heating the molding die 10 and the preform 3.

After the molding die 10 was heated to 400° C. as the first temperature in the heating step, the preform 3 was arranged in the molding die 10. Thereafter, the preform 3 was heated to 510° C. as the second temperature higher than the first temperature, and the preform 3 was softened until the viscosity of the preform 3 became a state suitable for press molding. Since the SiO₂ film was formed as the film 4 on the outer peripheral region of the preform 3, the temperature of the outer peripheral region was lower than that of the central region in the preform 3, with a temperature difference of 14.1° C.

In the next press molding step, the molding die 10 was brought into contact with the preform 3 by a press load of 4000 N to press the preform 3, and the optical member 5 having a plurality of inflection points was molded from the preform 3.

In the cooling step and the demolding step, the press load applied to the molding die 10 was unloaded when the temperature of the molding die 10 became 400° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-8

In Comparative Example 1-8, the same molding die 10 as in Example 1-8 was used, and the optical member 5 was molded in the same manner as in Example 1-8 from the preform 3 having the same shape as in Example 1-8 except that the film 4 was not formed. The press load was unloaded at the third temperature after the heating step, the molding step and the cooling step described above, but the demolding of the optical member 5 did not occur.

### Example 1-9

In Example 1-9, the optical member 5 having a plurality of inflection points was molded by the method for manufacturing the optical member according to the modification 2 of the first embodiment. The dimensions of the molded optical member 5 were: the outer diameter φ19.4 mm; the total height 2.9 mm; the center thickness 2.9 mm; the end thickness 1.1 mm; the optical effective diameter φ18.6 mm of the upper surface 5a; and the optical effective diameter φ18.3 mm of the lower surface 5a. The preform 3 made of optical glass for glass molding having a glass transition temperature of 616° C. was used. A SiO₂ film was formed as the film 4 on the preform 3. An infrared heater was used as the heater 14 used when heating the molding die 10 and the preform 3.

After the molding die 10 was heated to 560° C. as the first temperature in the heating step, the preform 3 was arranged in the molding die 10. Thereafter, the preform 3 was heated to 670° C. as the second temperature higher than the first temperature, and the preform 3 was softened until the viscosity of the preform 3 became a state suitable for press molding. Since the SiO₂ film was formed as the film 4 on the outer peripheral region of the preform 3, the temperature of the outer peripheral region of the preform 3 was lower than that of the central region, with a temperature difference of 13.2° C.

In the next press molding step, the molding die 10 was brought into contact with the preform 3 by a press load of 4000 N to press the preform 3, and the optical member 5 having a plurality of inflection points was molded from the preform 3.

In the cooling step and the demolding step, the press load applied to the molding die 10 was unloaded when the temperature of the molding die 10 became 560° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-9

In Comparative Example 1-9, the same molding die 10 as in Example 1-9 was used, and the optical member 5 was molded in the same manner as in Example 1-9 from the same preform 3 as in Example 1-9 except that the film 4 was not formed. The press load was unloaded at the third temperature after the heating step, the molding step and the cooling step described above, but the demolding of the optical member 5 did not occur. (Example 1-10)

In Example 1-10, the optical member 5 having a plurality of inflection points was molded by the method for manufacturing an optical member according to the modification 3 of the first embodiment. The dimensions of the molded optical member 5 were: the outer diameter φ10.0 mm; the total height 1.9 mm; the center thickness 1.0 mm; the end thickness 1.0 mm; the optical effective diameter φ9.1 mm of the upper surface 5a; the optical effective diameter φ8.3 mm of the lower surface 5b. The preform 3 made of optical glass for glass molding having a glass transition temperature of 500° C. was used. A SiO₂ film was formed as the film 4 on the preform 3. An infrared heater was used as the heater 14 used when heating the molding die 10 and the preform 3.

After the molding die 10 was heated to 450° C. as the first temperature in the heating step, the preform 3 was arranged in the molding die 10. Thereafter, the preform 3 was heated to 560° C. as the second temperature higher than the first temperature, and the preform 3 was softened until the viscosity of the preform 3 became a state suitable for press molding. Since the SiO₂ film was formed as the film 4 on the outer peripheral region of the preform 3, the temperature of the outer peripheral region was lower than that of the central region in the preform 3, with a temperature difference of 11.3° C.

In the next press molding step, the molding die 10 was brought into contact with the preform 3 by a press load of 4000 N to press the preform 3, and the optical member 5 having a plurality of inflection points was molded from the preform 3.

In the cooling step and the demolding step, the press load applied to the molding die 10 was unloaded when the temperature of the molding die 10 became 450° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the taken out optical member 5, the black paint could be easily applied to the outer peripheral region.

### Comparative Example 1-10

In Comparative Example 1-10, the same molding die 10 as in Example 1-10 was used, and the optical member 5 was molded in the same manner as in Example 1-10 from the same preform 3 as in Example 1-10 except that the film 4 was not formed. The press load was unloaded at the third temperature after the heating step, the molding step and the cooling step described above, but the demolding of the optical member 5 did not occur.

### Example 1-11

In Example 1-11, the optical member 5 having a plurality of inflection points was molded by the method for manufacturing an optical member according to the modification 3 of the first embodiment. The dimensions of the molded optical member 5 were: the outer diameter φ15.0 mm; the total height 2.9 mm; the center thickness 1.5 mm; the end thickness 1.5 mm; the optical effective diameter φ13.7 mm of the upper surface 5a; and the optical effective diameter φ12.5 mm of the lower surface 5b. The preform 3 made of optical glass for glass molding having a glass transition temperature of 612° C. was used. A ZrO₂ film was formed as the film 4 on the preform 3. An infrared heater was used as the heater 14 used when heating the molding die 10 and the preform 3.

After the molding die 10 was heated to 560° C. as the first temperature in the heating step, the preform 3 was arranged in the molding die 10. Thereafter, the preform 3 was heated to 670° C. as the second temperature higher than the first temperature, and the preform 3 was softened until the viscosity of the preform 3 became a state suitable for press molding. Since the ZrO₂ film was formed as the film 4 on the outer peripheral region of the preform 3, the temperature of the outer peripheral region was lower than that of the central region in the preform 3, with a temperature difference of 19.5° C.

In the next press molding step, the molding die 10 was brought into contact with the preform 3 by a press load of 4000 N to press the preform 3, and the optical member 5 having a plurality of inflection points was molded from the preform 3.

In the cooling step and the demolding step, the press load applied to the molding die 10 was unloaded when the temperature of the molding die 10 became 560° C. as the third temperature lower than the second temperature by using the gas inlet pipe 16. The optical member 5 which had been crushed until the press load was unloaded became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-11

In Comparative Example 1-11, the same molding die 10 as in Example 1-11 was used, and the optical member 5 was molded in the same manner as in Example 1-11 from the same preform 3 as in Example 1-11 except that the film 4 was not formed. The press load was unloaded at the third temperature after the heating step, the molding step and the cooling step described above, but the demolding of the optical member 5 did not occur.

### Example 1-12

In Example 1-12, the optical member 5 having a plurality of inflection points was molded by the method for manufacturing an optical member according to the modification 3 of the first embodiment. The dimensions of the molded optical member 5 were: the outer diameter φ20.0 mm; the total height 3.8 mm; the center thickness 2.0 mm; the end thickness 2.0 mm; the optical effective diameter φ 18.2 mm of the upper surface 5a; and the optical effective diameter φ16.6 mm of the lower surface 5b. The preform 3 made of optical glass for glass molding having a glass transition temperature of 616° C. was used. A CH film was formed as the film 4 on the preform 3. An infrared heater was used as the heater 14 used when heating the molding die 10 and the preform 3.

After the molding die 10 was heated to 560° C. as the first temperature in the heating step, the preform 3 was arranged in the molding die 10. Thereafter, the preform 3 was heated to 670° C. as the second temperature higher than the first temperature, and the preform 3 was softened until the viscosity of the preform 3 became a state suitable for press molding. Since the CH film was formed as the film 4 on the outer peripheral region of the preform 3, the temperature of the outer peripheral region was lower than that of the central region in the preform 3, with a temperature difference of 18.3° C.

In the next press molding step, the molding die 10 was brought into contact with the preform 3 by a load of 4000 N to press the preform 3, and the optical member 5 having a plurality of inflection points was molded from the preform 3.

In the cooling step and the demolding step, the press load applied to the molding die 10 was unloaded when the temperature of the molding die 10 became 560° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-12

In Comparative Example 1-12, the same molding die 10 as in Example 1-12 was used, and the optical member 5 was molded in the same manner as in Example 1-12 from the same preform 3 as in Example 1-12 except that the film 4 was not formed. The press load was unloaded at the third temperature after the heating step, the molding step and the cooling step described above, but the demolding of the optical member 5 did not occur.

### Example 1-13

In Example 1-13, the optical member 5 having a concave meniscus shape was molded by the method for manufacturing an optical member according to the modification 4 of the first embodiment. The dimensions of the molded optical member 5 were: the outer diameter φ9.7 mm; the total height 2.6 mm; the center thickness 1.4 mm; the end thickness 2.3 mm; the optical effective diameter φ7.2 mm of the upper surface 5a; and the optical effective diameter φ9.2 mm of the lower surface 5b. The preform 3 made of optical glass for glass molding having a glass transition temperature of 500° C. was used. A CH film was formed as the film 4 on the preform 3. An infrared heater was used as the heater 14 used when heating the molding die 10 and the preform 3.

After the molding die 10 was heated to 450° C. as the first temperature in the heating step, the preform 3 was arranged in the molding die 10. Thereafter, the preform 3 was heated to 560° C. as the second temperature higher than the first temperature, and the preform 3 was softened until the viscosity of the preform 3 became a state suitable for press molding. Since the CH film was formed as the film 4 on the outer peripheral region of the preform 3, the temperature of the outer peripheral region was lower than that of the central region in the preform 3, with a temperature difference of 20.5° C.

In the next press molding step, the molding die 10 was brought into contact with the preform 3 by a press load of 4000 N to press the preform 3, and the optical member 5 having a concave meniscus shape was molded.

In the cooling step and the demolding step, the press load applied to the molding die 10 was unloaded when the temperature of the molding die 10 became 450° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-13

In Comparative Example 1-13, the same molding die 10 as in Example 1-13 was used, and the optical member 5 was molded in the same manner as in Example 1-13 from the same preform 3 as in Example 1-13 except that the film 4 was not formed. The press load was unloaded at the third temperature after the heating step, the molding step and the cooling step described above, but the demolding of the optical member 5 did not occur.

### Example 1-14

In Example 1-14, the optical member 5 having a concave meniscus shape was molded by the method for manufacturing an optical member according to the modification 4 of the first embodiment. The dimensions of the molded optical member 5 were: the outer diameter φ14.5 mm; the total height 3.9 mm; the center thickness 0.6 mm; the end thickness 3.5 mm; the optical effective diameter φ10.9 mm of the upper surface 5a; and the optical effective diameter φ13.9 mm of the lower surface 5b. The preform 3 made of optical glass for glass molding having a glass transition temperature of 512° C. was used. A ZrO₂ film was formed as the film 4 on the preform 3. An infrared heater was used as the heater 14 used when heating the molding die 10 and the preform 3.

After the molding die 10 was heated to 450° C. as the first temperature in the heating step, the preform 3 was arranged in the molding die 10. Thereafter, the preform 3 was heated to 560° C. as the second temperature higher than the first temperature, and the preform 3 was softened until the viscosity of the preform 3 became a state suitable for press molding. Since the ZrO₂ film was formed as the film 4 on the outer peripheral region of the preform 3, the temperature of the outer peripheral region was lower than that of the central region in the preform 3, with a temperature difference of 21.0° C.

In the next press molding step, the molding die 10 was brought into contact with the preform 3 by a press load of 4000 N to press the preform 3, and the optical member 5 having a concave meniscus shape was molded from the preform 3.

In the cooling step and the demolding step, the press load applied to the molding die 10 was unloaded when the temperature of the molding die 10 became 450° C. as the third temperature lower than the second temperature by using the gas inlet pipe 16. When the press load was unloaded, the optical member 5 which had been compressed until then became deformable, and the optical member 5 was released from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-14

In Comparative Example 1-14, the same molding die 10 as in Example 1-14 was used, and the optical member 5 was molded in the same manner as in Example 1-14 from the same preform 3 as in Example 1-14 except that the film 4 was not formed. The press load was unloaded at the third temperature after the heating step, the molding step and the cooling step described above, but the demolding of the optical member 5 did not occur.

### Example 1-15

In Example 1-15, the optical member 5 having a concave meniscus shape was molded by the method for manufacturing an optical member according to the modification 4 of the first embodiment. The dimensions of the molded optical member 5 were: the outer diameter φ19.3 mm; the total height 5.3 mm; the center thickness 0.8 mm; the end thickness 4.6 mm; the optical effective diameter φ14.5 mm of the upper surface 5a; and the optical effective diameter φ18.5 mm of the lower surface 5b. The preform 3 made of optical glass for glass molding having a glass transition temperature of 512° C. was used. A SiO₂ film was formed as the film 4 on the preform 3. An infrared heater was used as the heater 14 used when heating the molding die 10 and the preform 3.

After the molding die 10 was heated to 460° C. as the first temperature in the heating step, the preform 3 was arranged in the molding die 10. Thereafter, the preform 3 was heated to 570° C. as the second temperature higher than the first temperature, and the preform 3 was softened until the viscosity of the preform 3 became a state suitable for press molding. Since the SiO₂ film was formed as the film 4 on the outer peripheral region of the preform 3, the temperature of the outer peripheral region was lower than that of the central region in the preform 3, with a temperature difference of 18.5° C.

In the next press molding step, the molding die 10 was brought into contact with the preform 3 by a press load of 4000 N to press the preform 3, and the optical member 5 having a concave meniscus shape was molded from the preform 3.

In the cooling step and the demolding step, the press load applied to the molding die 10 was unloaded when the temperature of the molding die 10 became 460° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-15

In Comparative Example 1-15, the same molding die 10 as in Example 1-15 was used, and the optical member 5 was molded in the same manner as in Example 1-15 from the same preform 3 as in Example 1-15 except that the film 4 was not formed. The press load was unloaded at the third temperature after the heating step, the molding step and the cooling step described above, but the demolding of the optical member 5 did not occur.

### Example 1-16

In Example 1-16, the optical member 5 having a biconcave shape was molded by the method for manufacturing an optical member according to the modification 5 of the first embodiment. The dimensions of the molded optical member 5 were: the outer diameter φ9.3 mm; the total height 2.9 mm; the center thickness 0.6 mm; the end thickness 2.9 mm; the optical effective diameter φ8.8 mm of the upper surface 5a; and the optical effective diameter φ8.7 mm of the lower surface 5b. The preform 3 made of optical glass for glass molding having a glass transition temperature of 458° C. was used. A ZrO₂ film was formed as the film 4 on the preform 3. An infrared heater was used as the heater 14 used when heating the molding die 10 and the preform 3.

After the molding die 10 was heated to 400° C. as the first temperature in the heating step, the preform 3 was arranged in the molding die 10. Thereafter, the preform 3 was heated to 510° C. as the second temperature higher than the first temperature, and the preform 3 was softened until the viscosity of the preform 3 became a state suitable for press molding. Since the ZrO₂ film was formed as the film 4 on the outer peripheral region of the preform, the temperature of the outer peripheral region was lower than that of the central region in the preform 3, with a temperature difference of 19.8° C.

In the next press molding step, the molding die 10 was brought into contact with the preform 3 by a press load of 4000 N to press the preform 3, and the optical member 5 having a biconcave shape was molded from the preform 3.

In the cooling step and the demolding step, the press load applied to the molding die 10 was unloaded when the temperature of the molding die 10 became 400° C. as the third temperature lower than the second temperature by using the gas inlet pipe 16. When the press load was unloaded, the optical member 5 which had been compressed until then became deformable, and the optical member 5 was released from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint can be easily applied to the outer peripheral region.

### Comparative Example 1-16

In Comparative Example 1-16, the same molding die 10 as in Example 1-16 was used, and the optical member 5 was molded in the same manner as in Example 1-16 from the same preform 3 as in Example 1-16 except that the film 4 was not formed. The press load was unloaded at the third temperature after the heating step, the molding step and the cooling step described above, but the demolding of the optical member 5 did not occur.

### Example 1-17

In Example 1-17, the optical member 5 having a biconcave shape was molded by the method for manufacturing an optical member according to the modification 5 of the first embodiment. The dimensions of the molded optical member 5 were: the outer diameter φ14.8 mm; the total height 5.6 mm; the center thickness 1.0 mm; the end thickness 5.6 mm; the optical effective diameter φ13.7 mm of the upper surface 5a; and the optical effective diameter φ13.9 mm of the lower surface 5b. The preform 3 made of optical glass for glass molding having a glass transition temperature of 612° C. was used. An SnO₂ film was formed as the film 4 on the preform 3. An infrared heater was used as the heater 14 used when heating the molding die 10 and the preform 3.

After the molding die 10 was heated to 560° C. as the first temperature in the heating step, the preform 3 was arranged in the molding die 10. Thereafter, the preform 3 was heated to 670° C. as the second temperature higher than the first temperature, and the preform 3 was softened until the viscosity of the preform 3 became a state suitable for press molding. Since the SnO₂ film was formed as the film 4 on the outer peripheral region of the preform 3, the temperature of the outer peripheral region was lower than that of the central region in the preform 3, with a temperature difference of 19.3° C.

In the next press molding step, the molding die 10 was brought into contact with the preform 3 by a press load of 4000 N to press the preform 3, and the optical member 5 having a biconcave shape was molded from the preform 3.

In the cooling step and the demolding step, the press load applied to the molding die 10 was unloaded when the temperature of the molding die 10 became 560° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-17

In Comparative Example 1-17, the same molding die 10 as in Example 1-17 was used, and the optical member 5 was molded in the same manner as in Example 1-17 from the same preform 3 as in Example 1-17 except that the film 4 was not formed. The press load was unloaded at the third temperature after the heating step, the molding step and the cooling step described above, but the demolding of the optical member 5 did not occur.

### Example 1-18

In Example 1-18, the optical member 5 having a biconcave shape according to the modification 5 of the first embodiment was molded. The dimensions of the molded optical member 5 were: the outer diameter φ19.4 mm; the total height 6.0 mm; the center thickness 1.3 mm; the end thickness 6.0 mm; the optical effective diameter φ18.0 mm of the upper surface 5a; and the optical effective diameter φ18.3 mm of the lower surface 5b. The preform 3 made of optical glass for glass molding having a glass transition temperature of 616° C. was used. A ZrO₂ film was formed as the film 4 on the preform 3. An infrared heater was used as the heater 14 used when heating the molding die 10 and the preform 3.

After the molding die 10 was heated to 560° C. as the first temperature in the heating step, the preform 3 was arranged in the molding die 10. Thereafter, the preform 3 was heated to 670° C. as the second temperature higher than the first temperature, and the preform 3 was softened until the viscosity of the preform 3 became a state suitable for press molding. Since the ZrO₂ film was formed as the film 4 on the outer peripheral region of the preform 3, the temperature of the outer peripheral region was lower than that of the central region in the preform 3, with a temperature difference of 19.3° C.

In the next press molding step, the molding die 10 was brought into contact with the preform 3 by a press load of 4000 N to press the preform 3, and the optical member 5 having a biconcave shape was molded from the preform 3.

In the cooling step and the demolding step, the press load applied to the molding die 10 was unloaded when the temperature of the molding die 10 became 560° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated). Since the cracked film 4 adhered to the outer peripheral region of the optical member 5, which was taken out, a black paint could be easily applied to the outer peripheral region.

### Comparative Example 1-18

In Comparative Example 1-18, the same molding die 10 as in Example 1-18 was used, and the optical member 5 was molded in the same manner as in Example 1-18 from the same preform 3 as in Example 1-18 except that the film 4 was not formed. The press load was unloaded at the third temperature after the heating step, the molding step and the cooling step described above, but the demolding of the optical member 5 did not occur.

### Comparative Example 1-19

In Comparative Example 1-19, the same molding die 10 as in Example 1-18 was used, and the optical member 5 was molded from the same preform 3 as in Example 1-18 except that no film 4 was formed. Further, in Comparative Example 1-19, the optical member 5 was molded by performing press molding by heating the preform 3 so that the temperature of the central region was higher than that of the outer peripheral region in the preform 3 by 9.0° C. in the heating step. The press load was unloaded at the third temperature after the heating step, the molding step and the cooling step described above, but the demolding of the optical member 5 did not occur.

### Comparative Example 1-20

In Comparative Example 1-20, the same molding die 10 as in Example 1-18 was used, and the optical member 5 was molded from the same preform 3 as in Example 1-18 except that the film 4 was not formed. Further, in Comparative Example 1-20, the optical member 5 was molded by performing press molding by heating the preform 3 so that the temperature of the central region was higher than that of the outer peripheral region in the preform 3 by 11.0° C. in the heating step. The press load was unloaded at the third temperature after the heating step, the molding step and the cooling step, then the demolding of the optical member 5 occurred.

The following Table 1-1, Table 1-2 and Table 2 show the shape and outer diameter of the optical member 5, the glass transition temperature of the optical glass constituting the preform 3, the type of the film 4, and the demolding occurrence with respect to each of the examples and the comparative examples of the first embodiment. The demolding occurrence is indicated by “Yes” when the demolding occurred and “No” when the demolding did not occur.

TABLE 1-1

| | | | Glass transition | | |
|---|---|---|---|---|---|
| | | Outer | temperature of | | |
| | | diameter | optical glass | | Demolding |
| | Shape | [mm] | [° C.] | Film type | occurrence |
| Example 1-1 | Biconvex | 10.0 | 500 | SiO₂ | Yes |
| Comparative | Biconvex | 10.0 | 500 | None | No |
| Example 1-1 | | | | | |
| Example 1-2 | Biconvex | 15.0 | 512 | ZrO₂ | Yes |
| Comparative | Biconvex | 15.0 | 512 | None | No |
| Example 1-2 | | | | | |
| Example 1-3 | Biconvex | 20.0 | 512 | CH | Yes |
| Comparative | Biconvex | 20.0 | 512 | None | No |
| Example 1-3 | | | | | |
| Example 1-4 | Convex | 9.8 | 458 | DLC | Yes |
| | meniscus | | | | |
| Comparative | Convex | 9.8 | 458 | None | No |
| Example 1-4 | meniscus | | | | |
| Example 1-5 | Convex | 14.7 | 512 | DLC | Yes |
| | meniscus | | | | |
| Comparative | Convex | 14.7 | 512 | None | No |
| Example 1-5 | meniscus | | | | |
| Example 1-6 | Convex | 19.5 | 512 | Al₂O₃ | Yes |
| | meniscus | | | | |
| Comparative | Convex | 19.5 | 512 | None | No |
| Example 1-6 | meniscus | | | | |
| Example 1-7 | Lens 1 with | 9.7 | 500 | ZrO₂ | Yes |
| | inflection points | | | | |
| Comparative | Lens 1 with | 9.7 | 500 | None | No |
| Example 1-7 | inflection points | | | | |
| Example 1-8 | Lens 1 with | 14.6 | 458 | SiO₂ | Yes |
| | inflection points | | | | |
| Comparative | Lens 1 with | 14.6 | 458 | None | No |
| Example 1-8 | inflection points | | | | |
| Example 1-9 | Lens 1 with | 19.4 | 616 | SiO₂ | Yes |
| | inflection points | | | | |
| Comparative | Lens 1 with | 19.4 | 616 | None | No |
| Example 1-9 | inflection points | | | | |

TABLE 1-2

| | | | Glass transition | | |
|---|---|---|---|---|---|
| | | Outer | temperature of | | |
| | | diameter | optical glass | | Demolding |
| | Shape | [mm] | [° C.] | Film type | occurrence |
| Example 1-10 | Lens 2 with | 10.0 | 500 | SiO₂ | Yes |
| | inflection points | | | | |
| Comparative | Lens 2 with | 10.0 | 500 | None | No |
| Example 1-10 | inflection points | | | | |
| Example 1-11 | Lens 2 with | 15.0 | 612 | ZrO₂ | Yes |
| | inflection points | | | | |
| Comparative | Lens 2 with | 15.0 | 612 | None | No |
| Example 1-11 | inflection points | | | | |
| Example 1-12 | Lens 2 with | 20.0 | 616 | CH | Yes |
| | inflection points | | | | |
| Comparative | Lens 2 with | 20.0 | 616 | None | No |
| Example 1-12 | inflection points | | | | |
| Example 1-13 | Concave | 9.7 | 500 | CH | Yes |
| | meniscus | | | | |
| Comparative | Concave | 9.7 | 500 | None | No |
| Example 1-13 | meniscus | | | | |
| Example 1-14 | Concave | 14.5 | 512 | ZrO₂ | Yes |
| | meniscus | | | | |
| Comparative | Concave | 14.5 | 512 | None | No |
| Example 1-14 | meniscus | | | | |
| Example 1-15 | Concave | 19.3 | 512 | SiO₂ | Yes |
| | meniscus | | | | |
| Comparative | Concave | 19.3 | 512 | None | No |
| Example 1-15 | meniscus | | | | |
| Example 1-16 | Biconcave | 9.3 | 458 | ZrO₂ | Yes |
| Comparative | Biconcave | 9.3 | 458 | None | No |
| Example 1-16 | | | | | |
| Example 1-17 | Biconcave | 14.8 | 612 | SnO₂ | Yes |
| Comparative | Biconcave | 14.8 | 612 | None | No |
| Example 1-17 | | | | | |
| Example 1-18 | Biconcave | 19.4 | 616 | ZrO₂ | Yes |
| Comparative | Biconcave | 19.4 | 616 | None | No |
| Example 1-18 | | | | | |
| Comparative | Biconcave | 19.4 | 616 | None | No |
| Example 1-19 | | | | | |
| Comparative | Biconcave | 19.4 | 616 | None | Yes |
| Example 1-20 | | | | | |

### Second Embodiment

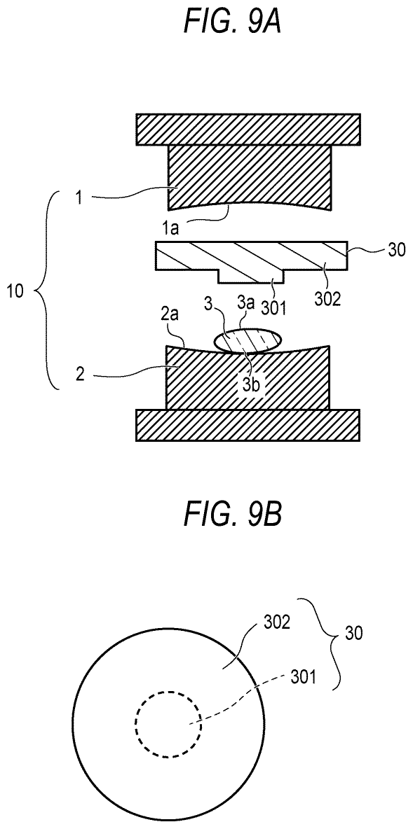

An apparatus for manufacturing an optical member and a method for manufacturing an optical member according to a second embodiment will be described with reference to FIG. 9A to FIG. 12B. Note that descriptions of the same components as those of the first embodiment will be omitted or simplified. Whereas, in the first embodiment, the case where a temperature distribution is formed in the preform 3 by the film 4 is described, in the present embodiment, a case where a temperature distribution is formed in the preform 3 by a heater 30 is described.

First, an optical member molding apparatus 100 according to the present embodiment will be described with reference to FIG. 9A and FIG. 9B. FIG. 9A is a cross-sectional view illustrating a molding die 10, a preform 3, and a heater 30 in the optical member molding apparatus 100 according to the present embodiment. FIG. 9B is a plan view illustrating the heater 30 in the optical member molding apparatus 100 according to the present embodiment. FIG. 9A illustrates a state of the molding die 10 before molding.

The basic configuration of the optical member molding apparatus 100 according to the present embodiment is the same as the configuration of the optical member molding apparatus 100 according to the first embodiment. The optical member molding apparatus 100 according to the present embodiment is different from the configuration of the optical member molding apparatus 100 according to the first embodiment in that the optical member molding apparatus 100 according to the present embodiment includes the heater 30 instead of the heater 14 as illustrated in FIG. 9A and FIG. 9B. Note that the molding apparatus 100 may include the heater 30 together with the heater 14.

The heater 30 is a heating unit that heats the molding die 10 including the upper die member 1 and the lower die member 2 and the preform 3 to a temperature suitable for press molding. Specifically, the heater 30 is, for example, an infrared ray heater, and heats the molding die 10 and the preform 3 by irradiating energy with electromagnetic waves such as infrared rays or the like. The heater output control device 22 controls the output of the heater 30. The operation of the heater output control device 22 is controlled by the controller 26 based on the temperature information outputted from the temperature sensor 20. The heater 30 may also be used for heating the molding die 10 and the preform 3 in the first embodiment as in the present embodiment.

The heater 30 is configured to be moved and arranged between the upper die member 1 and the lower die member 2 in the molding die 10 so as to face the preform 3 on the molding surface 2a of the lower die member 2 in the heating step. Further, the heater 30 is configured to be moved and retreated from between the upper die member 1 and the lower die member 2 so as not to interfere with press molding by the upper die member 1 and the lower die member 2 in the molding step. The movement of the heater 30 is controlled by a controller 26.

The heater 30 has a central portion 301 and an outer peripheral portion 302 positioned on the outer periphery of the central portion 301. The central portion 301 faces the central region of the preform 3 and heats the central region of the preform 3 in the heating step. The outer peripheral portion 302 faces the outer peripheral region of the preform 3 and heats the outer peripheral region of the preform 3 in the heating step. The outer peripheral region of the preform 3 here corresponds to the outer peripheral region of the preform 3 on which the film 4 is formed in the first embodiment. The heater 30 is configured so that a distance between the central portion 301 and the central region of the preform 3 becomes closer than a distance between the outer peripheral portion 302 and the outer peripheral region of the preform 3 in a state facing the preform 3 in the heating step. That is, the heater 30 is configured so that the central portion 301 becomes convex to the side of the preform 3 than the outer peripheral portion 302 in a state facing the preform 3 in the heating step. Thus, the heating surface of central portion 301 of the heater 30 becomes closer to the preform 3 than the heating surface of the outer peripheral portion 302 in the heating step. Since the heater 30 with such a configuration can increase the amount of energy applied to the central region of the preform 3 more than the amount of energy applied to the outer peripheral region of the preform 3, the temperature of the central region of the preform 3 can be made higher than that of the outer peripheral region of the preform 3. Thus, the heater 30 irradiates the central region of the preform 3 with larger energy than the outer peripheral region of the preform 3 to form a temperature distribution in the preform 3 similar to the first embodiment.

The molding die 10 can be configured similarly to the first embodiment including a shape including the molding surfaces 1a and 2a, the surface roughness of the molding surfaces 1a and 2a, the materials, films on the molding surfaces 1a and 2a, and the like.

The preform 3 can be constituted in the same manner as the first embodiment except that the film 4 is not formed. Note that, also in the present embodiment, the film 4 may be formed on the outer peripheral region of the preform 3 as in the first embodiment.

In the method for manufacturing the optical member according to the present embodiment, the preform 3 is heated by the heater 30 while the heater 30 faces the preform 3 in the heating step, and the heater 30 is moved from between the upper die member 1 and the lower die member 2 and retreated in the molding step. Except for these points, in the method for manufacturing the optical member according to the present embodiment, the optical member 5 can be manufactured in the same manner as in the first embodiment.

As described above, in the present embodiment, the energy amount applied to the central region of the preform 3 can be made larger than the energy amount applied to the outer peripheral region of the preform 3 by heating the preform 3 by the heater 30 in the heating step. The temperature of the outer peripheral region of the preform 3 becomes lower than that of the central region of the preform 3 because the temperature of the central region of the preform 3 becomes higher as the energy amount applied to the central region of the preform 3 becomes larger. The viscosity of the material of the preform 3 such as glass or the like becomes higher as the temperature becomes lower. Therefore, the viscosity of the material in the outer peripheral region of the preform 3 becomes higher than that of the material in the central region of the preform 3 due to the temperature distribution formed in the preform 3 by the heating step using the heater 30. Thus, when the preform 3 is press-molded in the molding step in a state where the viscosity of the material is higher in the outer peripheral region than in the central region, it becomes difficult for the material to bite into the molding surfaces 1a and 2a of the molding die 10 in the outer peripheral region of the preform 3. Therefore, the true contact area between the outer peripheral region of the preform 3 and the molding surfaces 1a and 2a of the molding die 10 is reduced, and the adhesive force between them is reduced. Since the adhesive force between the outer peripheral region of the optical member 5 molded from the preform 3 and the molding die 10 can be reduced in this way, demolding occurs from the outer peripheral region of the optical member 5 in the cooling step or the demolding step.

Accordingly, in the present embodiment also, the demolding can be easily started from the outer peripheral region of the optical member 5 molded from the preform 3 by reducing the adhesive force between the preform 3 and the molding surfaces 1a and 2a of the molding die 10 in the outer peripheral region of the preform 3. Therefore, according to the present embodiment, the demolding between the molding die 10 and the optical member 5 can be easily realized without causing scratches or cracks even when the optical member 5 has a small diameter or a thin wall with low strength.

### <Modification 1 of Second Embodiment>

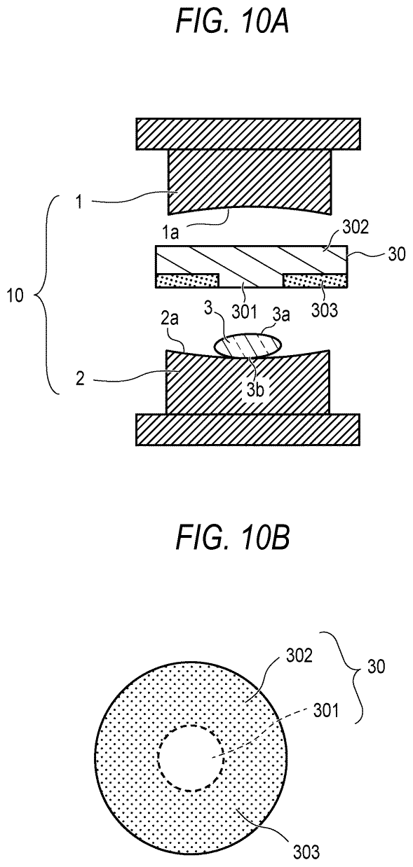

A modification 1 of the second embodiment will be described with reference to FIG. 10A and FIG. 10B. FIG. 10A is a cross-sectional view illustrating a molding die 10, a preform 3 and a heater 30 in a molding apparatus 100 according to the present modification. FIG. 10B is a plan view illustrating the heater 30 in the molding apparatus 100 according to the present modification. FIG. 10A illustrates a state of the molding die 10 before molding.

The configuration of the molding apparatus 100 according to the present modification is the same as the configuration of the molding apparatus 100 according to the second embodiment except for the configuration of the heater 30. In the present modification, the shape of the heater 30 is changed. That is, in the present modification, as illustrated in FIG. 10A and FIG. 10B, a heat insulating member 303 is provided on the surface of the outer peripheral portion 302 of the heater 30 on the side of the preform 3. The heat insulating member 303 insulates heat radiated from the outer peripheral portion 302 of the heater 30 toward the preform 3. Note that the heat insulating member 303 is not necessarily provided on the surface of the outer peripheral portion 302 of the heater 30 on the side of the preform 3, but may be provided between the outer peripheral portion 302 of the heater 30 and the outer peripheral region of the preform 3.

Thus, in the present modification, the heat insulating member 303 is provided on the surface of the outer peripheral portion 302 of the heater 30. With this configuration, the energy amount applied to the outer peripheral region of the preform 3 by the heater 30 can be made smaller than the energy amount applied to the central region of the preform 3 by the heater 30. In this way, in the present modification, the temperature of the outer peripheral region of the preform 3 is made lower than that of the central region of the preform 3, and the temperature distribution similar to that of the first embodiment can be formed in the preform 3.

### <Modification 2 of Second Embodiment>

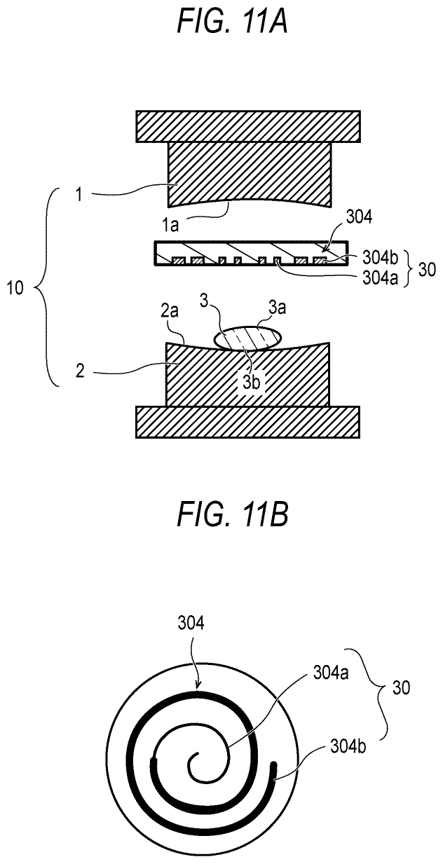

A modification 2 of the second embodiment will be described with reference to FIG. 11A and FIG. 11B. FIG. 11A is a cross-sectional view illustrating a molding die 10, a preform 3 and a heater 30 in a molding apparatus 100 according to the present modification. FIG. 11B is a plan view illustrating the heater 30 in the molding apparatus 100 according to the present modification. FIG. 11A illustrates a state of the molding die 10 before molding.

The configuration of the molding apparatus 100 according to the present modification is the same as the configuration of the molding apparatus 100 according to the second embodiment except for the configuration of the heater 30. In the present modification, the configuration of the heater 30 is changed and its heat generation distribution is changed. That is, in the present modification, as illustrated in FIG. 11A and FIG. 11B, the heater 30 has a band-like heating element 304 formed of, for example, an electric heating wire. The heating element 304 is spirally arranged from the central portion to the outer peripheral portion in the heater 30. The heating element 304 has a narrow width portion 304a in the central portion and a wide width portion 304b in the outer peripheral portion, which is thicker than the narrow width portion 304a. The narrow width portion 304a faces the central region of the preform 3 and heats the central region of the preform 3 in the heating step. The wide width portion 304b faces the outer peripheral region of the preform 3 and heats the outer peripheral region of the preform 3 in the heating step. The density of the heating element 304 is lower in the wide width portion 304b than in the narrow width portion 304a.

Thus, in the present modification, the density of the heating element 304 in the outer peripheral region of the heater 30 is lower than that of the narrow width portion 304a in the central portion. With this configuration, the energy amount applied to the outer peripheral region of the preform 3 by the heater 30 can be made smaller than the energy amount applied to the central region of the preform 3 by the heater 30. In this way, in the present modification, the temperature of the outer peripheral region of the preform 3 is made lower than that of the central region of the preform 3, and the temperature distribution similar to that of the first embodiment can be formed in the preform 3.

### <Modification 3 of Second Embodiment>

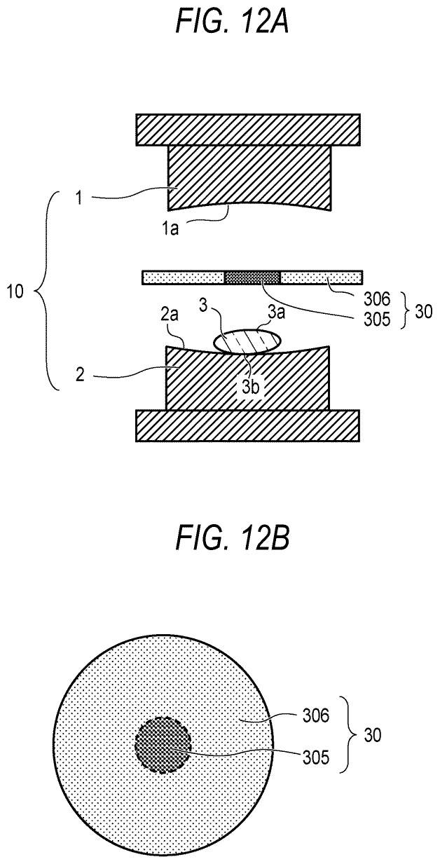

A modification 3 of the second embodiment will be described with reference to FIG. 12A and FIG. 12B. FIG. 12A is a cross-sectional view illustrating a molding die 10, a preform 3 and a heater 30 in a molding apparatus 100 according to the present modification. FIG. 12B is a plan view illustrating the heater 30 in the molding apparatus 100 according to the present modification. FIG. 12A illustrates a state of the molding die 10 before molding.

The configuration of the molding apparatus 100 according to the present modification is the same as the configuration of the molding apparatus 100 according to the second embodiment except for the configuration of the heater 30. In the present modification, the configuration of the heater 30 is changed and its heat generation distribution is changed. That is, in the present modification, as illustrated in FIG. 12A and FIG. 12B, the heater 30 has electric heating elements 305 and 306. The electric heating element 305 is arranged in the central portion of the heater 30, and the electric heating element 306 is arranged in the outer peripheral portion of the heater 30. The electric heating element 305 heats the central region of the preform 3, and the electric heating element 306 heats the outer peripheral region of the preform 3. The electric power density of the electric heating element 306 in the outer peripheral region is lower than the electric power density of the electric heating element 305 in the central portion.

Thus, in the present modification, the electric power density of the electric heating element 306 in the outer peripheral region is lower than the electric power density of the electric heating element 305 in the central portion of the heater 30. With this configuration, the energy amount applied to the outer peripheral region of the preform 3 by the heater 30 can be made smaller than the energy amount applied to the central region of the preform 3 by the heater 30. In this way, in the present modification, the temperature of the outer peripheral region of the preform 3 is made lower than that of the central region of the preform 3, and the temperature distribution similar to that of the first embodiment can be formed in the preform 3.

### Example 2-1

In Example 2-1, the optical member 5 having a biconvex shape was molded by the method for manufacturing an optical member according to a second embodiment. The dimensions of the molded optical member 5 were: the outer diameter φ20.0 mm; the total height 5.8 mm; the center thickness 5.8 mm; the end thickness 2.8 mm; the optical effective diameter φ18.7 mm of the upper surface 5a; and the optical effective diameter φ17.8 mm of the lower surface 5b. The preform 3 made of optical glass for glass molding having a glass transition temperature of 512° C. was used. An infrared heater was used as the heater 30 used when heating the molding die 10 and the preform 3. This infrared heater had a shape in which the surface of the heater 30 was raised only in the portion that heated the central region of the preform 3 to give more energy to the central region than to the outer peripheral region in the preform 3.

After the molding die 10 was heated to 460° C. as the first temperature in the heating step, the preform 3 was arranged in the molding die 10. Thereafter, the preform 3 was heated to 570° C. as the second temperature higher than the first temperature, and the preform 3 was softened until the viscosity of the preform 3 became a state suitable for press molding. Since more energy was given to the central region in the preform 3, the temperature of the outer peripheral region was lower than that of the central region in the preform 3, with a temperature difference of 10.6° C.

In the next press molding step, the molding die 10 was brought into contact with the preform 3 by a load of 4000 N to press the preform 3, and the optical member 5 having a biconvex shape was molded from the preform 3.

In the cooling step and the demolding step, the press load applied to the molding die 10 was unloaded when the temperature of the molding die 10 became 460° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated).

### Comparative Example 2-1

In Comparative Example 2-1, the same molding die 10 as in Example 2-1 and the same preform 3 as in Example 2-1 were used, and the optical member 5 was molded by using a flat infrared heater instead of the heater 30. The press load was unloaded at the third temperature after the heating step, the molding step and the cooling step described above, the demolding of the optical member 5 did not occur.

### Example 2-2

In Example 2-2, the optical member 5 having a biconvex shape was molded by the method for manufacturing an optical member according to the modification 1 of the second embodiment. The dimensions of the molded optical member 5 were: the outer diameter φ20.0 mm; the total height of 5.8 mm; the center thickness 5.8 mm; the end thickness 2.8 mm; the optical effective diameter φ18.7 mm of the upper surface 5a; and the optical effective diameter φ17.8 mm of the lower surface 5b. The preform 3 made of optical glass for glass molding having a glass transition temperature of 512° C. was used. An infrared heater was used as the heater 30 used when heating the molding die 10 and the preform 3. This infrared heater had a portion that heated the outer peripheral region of the preform 3, which was covered with the heat insulating member 303 to give more energy to the central region than to the outer peripheral region in the preform 3.

After the molding die 10 was heated at 460° C. as the first temperature in the heating step, the preform 3 was arranged in the molding die 10. Thereafter, the preform 3 was heated to 570° C. as the second temperature higher than the first temperature, and the preform 3 was softened until the viscosity of the preform 3 became a state suitable for press molding. Since more energy was given to the central region in the preform 3, the temperature of the outer peripheral region was lower than that of the central region in the preform 3, with a temperature difference of 11.1° C.

In the next press molding step, the molding die 10 was brought into contact with the preform 3 by a press load of 4000 N to press the preform 3, and the optical member 5 having a biconvex shape was molded from the preform 3.

In the cooling step and the demolding step, the press load applied to the molding die 10 was unloaded when the temperature of the molding die 10 became 460° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member was moved upward to open the molding die 10, and the optical member 5 was taken out from the molding die 10 by an optical member transport mechanism (not illustrated).

### Comparative Example 2-2

In Comparative Example 2-2, the same molding die 10 as in Example 2-2 and the same preform 3 as in Example 2-2 were used, and the optical member 5 was molded by using the infrared heater used in Comparative Example 2-1 instead of the heater 30. The press load was unloaded at the third temperature after the heating step, the molding step and the cooling step described above, but the demolding of the optical member 5 did not occur.

### Example 2-3

In Example 2-3, the optical member 5 having a biconvex shape was molded by the method for manufacturing an optical member according to the modification 2 of the second embodiment. The dimensions of the molded optical member 5 were: the outer diameter φ20.0 mm; the total height 5.8 mm; the center thickness 5.8 mm; the end thickness 2.8 mm; the optical effective diameter φ18.7 mm of the upper surface 5a; and the optical effective diameter φ17.8 mm of the lower surface 5b. The preform 3 made of optical glass for glass molding having a glass transition temperature of 512° C. was used. An infrared heater was used as the heater 30 used when heating the molding die 10 and the preform 3. This infrared heater had a configuration in which the thickness of the wide width portion 304b of the heating element 304 heating the outer peripheral region of the preform 3 was thicker than that of the narrow width portion 304a of the heating element 304 heating the central region of the preform 3 to give more energy to the central region than to the outer peripheral region in the preform 3. The temperature of the outer peripheral region of the preform 3 was lowered by decreasing the density of the heating element 304 by increasing the width of the wide width portion 304b of the heating element 304.

After the molding die 10 was heated to 460° C. as the first temperature in the heating step, the preform 3 was arranged in the molding die 10. Thereafter, the preform 3 was heated to 570° C. as the second temperature higher than the first temperature, and the preform 3 was softened until the viscosity of the preform 3 became a state suitable for press molding. Since more energy was given to the central region in the preform 3, the temperature of the outer peripheral region was lower than that of the central region in the preform 3, with a temperature difference of 10.8° C.

In the next press molding step, the molding die 10 was brought into contact with the preform 3 by a press load of 4000 N to press the preform 3, and the optical member 5 having a biconvex shape was molded from the preform 3.

In the cooling step and the demolding step, the press load applied to the molding die 10 was unloaded when the temperature of the molding die 10 became 460° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated).

### Comparative Example 2-3

In Comparative Example 2-3, the same molding die 10 as in Example 2-3 and the same preform 3 as in Example 2-3 were used, and the optical member 5 was molded by using the infrared heater used in Comparative Example 2-1 instead of the heater 30. The press load was unloaded at the third temperature after the heating step, the molding step and the cooling step described above, but the demolding of the optical member 5 did not occur.

### Example 2-4

In Example 2-4, the optical member 5 having a biconvex shape was molded by the method for manufacturing an optical member according to the modification 3 of the second embodiment. The dimensions of the molded optical member 5 were: the outer diameter φ20.0 mm; the total height 5.8 mm; the center thickness 5.8 mm; the end thickness 2.8 mm; the optical effective diameter φ18.7 mm of the upper surface 5a; and the optical effective diameter φ17.8 mm of the lower surface 5b. The preform 3 made of optical glass for glass molding having a glass transition temperature of 512° C. was used. An infrared heater was used for the heater 30 used when heating the molding die 10 and the preform 3. This infrared heater had the electric heating elements 305 and 306 whose electric power density was different between the central portion and the outer peripheral portion in order to give more energy to the central region than to the outer peripheral region in the preform 3. The electric heating element 305 was arranged at the central portion corresponding to the central region of the preform 3 and had a higher electric power density. The electric heating element 306 was arranged at the outer peripheral portion corresponding to the outer peripheral region of the preform 3 and had a lower electric power density. Since the electric power density of the central portion was made higher than that of the outer peripheral portion in the heater 30, more energy could be given to the central region of the preform 3.

After the molding die 10 was heated to 460° C. as the first temperature in the heating step, the preform 3 was arranged in the molding die 10. Thereafter, the preform 3 was heated to 570° C. as the second temperature higher than the first temperature, and the preform 3 was softened until the viscosity of the preform 3 became a state suitable for press molding. Since more energy was given to the central region in the preform 3, the temperature of the outer peripheral region was lower than that of the central region in the preform 3, with a temperature difference of 18.5° C.

In the next press molding step, the molding die 10 was brought into contact with the preform 3 by a press load of 4000 N to press the preform 3, and the optical member 5 having a biconvex shape was molded from the preform 3.

In the cooling step and the demolding step, the press load applied to the molding die 10 was unloaded when the temperature of the molding die 10 became 460° C. as the third temperature lower than the second temperature by using the gas inlet pipe 16. When the press load was unloaded, the optical member 5 which had been compressed until then became deformable, and the optical member 5 was demolded from the molding die 10.

Thereafter, the upper die member 1 of the molding die 10 on the upper side of the optical member 5 was moved upward to open the molding die 10, and the optical member 5 was taken out from the molding die 10 by an optical member transport mechanism (not illustrated).

### Comparative Example 2-4

In Comparative Example 2-4, the same molding die 10 as in Example 2-4 and the same preform 3 as in Example 2-4 were used, and the optical member 5 was molded by using the infrared heater used in Comparative Example 2-1 instead of the heater 30. The press load was unloaded at the third temperature after the heating step, the molding step and the cooling step described above, but the demolding of the optical member 5 did not occur.

The following Table 2 shows the shape and outer diameter of the optical member 5, the glass transition temperature of the optical glass constituting the preform 3, the configuration of the heater 30, and the demolding occurrence with respect to each of the examples and the comparative examples of the second embodiment. The demolding occurrence is indicated by “Yes” when the demolding occurred and “No” when the demolding did not occur.

TABLE 2

| | | | Glass transition | | |
|---|---|---|---|---|---|
| | | Outer | temperature of | | |
| | | diameter | optical glass | | Demolding |
| | Shape | [mm] | [° C.] | Configuration of heater | occurrence |
| Example 2-1 | Biconvex | 20.0 | 512 | Heater whose heating surface | Yes |
| | | | | in central portion to heat | |
| | | | | central region of preform was | |
| | | | | made closer to preform | |
| Comparative | Biconvex | 20.0 | 512 | Flat heater | No |
| Example 2-1 | | | | | |
| Example 2-2 | Biconvex | 20.0 | 512 | Heater whose outer peripheral | Yes |
| | | | | portion to heat outer peripheral | |
| | | | | region of preform was covered | |
| | | | | with insulating member | |
| Comparative | Biconvex | 20.0 | 512 | Flat heater | No |
| Example 2-2 | | | | | |
| Example 2-3 | Biconvex | 20.0 | 512 | Heater whose heating element | Yes |
| | | | | in portion to heat central region | |
| | | | | of preform had narrower width | |
| Comparative | Biconvex | 20.0 | 512 | Flat heater | No |
| Example 2-3 | | | | | |
| Example 2-4 | Biconvex | 20.0 | 512 | Heater whose electric heating | Yes |
| | | | | element to heat outer | |
| | | | | peripheral region of preform | |
| | | | | had lower electric power | |
| | | | | density | |
| Comparative | Biconvex | 20.0 | 512 | Flat heater | No |
| Example 2-4 | | | | | |

### Third Embodiment

An interchangeable lens, a camera, and an information terminal according to a third embodiment of the present disclosure will be described with reference to FIG. 13A to FIG. 15B. Note that descriptions of the same components as those of the first and second embodiments are omitted or simplified.

The optical member 5 manufactured by the method for manufacturing an optical member according to the first or second embodiment as described above may be used for various apparatuses. In the present embodiment, an interchangeable lens, a camera and an information terminal will be described as examples of equipment, apparatuses, devices, or instruments using the optical member 5.

FIG. 13A and FIG. 13B are a schematic view illustrating an interchangeable lens 201 in which the optical member 5 is used and a cross-sectional view illustrating a lens unit 101 thereof, respectively. As illustrated in FIG. 13A, the interchangeable lens 201 includes a lens unit 101. As illustrated in FIG. 13B, the lens unit 101 includes a plurality of optical members 102, 103, and 104, and a lens barrel 105. The lens barrel 105 is a support body that supports the plurality of optical members 102, 103, and 104 so as to make the plurality of optical members 102, 103, and 104 aligned in the optical axis direction of the lens unit 101. The optical member 5 is used as a part or all of the plurality of optical members 102, 103, and 104. The lens unit 101 guides incident light through the plurality of optical members 102, 103, and 104 to an imaging element 106 of a lens interchangeable camera with the interchangeable lens 201 attached thereto.

FIG. 14A and FIG. 14B are a schematic view illustrating a camera 202 in which the optical member 5 is used and a cross-sectional view illustrating a lens unit 101 thereof, respectively. As illustrated in FIG. 14A, the camera 202 includes a lens unit 101 and a housing 2021 that houses the lens unit 101. As illustrated in FIG. 14B, the lens unit 101 includes a plurality of optical members 102, 103, and 104 and a lens barrel 105. The lens barrel 105 is a support body that supports the plurality of optical members 102, 103, and 104 so as to make the plurality of optical members 102, 103, and 104 aligned in the optical axis direction of the lens unit 101. The optical member 5 is used as a part or all of the plurality of optical members 102, 103, and 104. The lens unit 101 guides incident light through the plurality of optical members 102, 103, and 104 to an imaging element 106 of the camera 202.

FIG. 15A and FIG. 15B are a schematic diagram illustrating an information terminal 203 in which the optical member 5 is used and a cross-sectional diagram illustrating a lens unit 101 thereof, respectively. As illustrated in FIG. 15A, the information terminal 203 is a smartphone or the like and includes a lens unit 101 of a mounted camera thereto and a housing 2031 that houses the lens unit 101. As illustrated in FIG. 15B, the lens unit 101 includes a plurality of optical members 102, 103, and 104 and a lens barrel 105. The lens barrel 105 is a support body that supports the plurality of optical members 102, 103, and 104 so as to make the plurality of optical members 102, 103, and 104 aligned in the optical axis direction of the lens unit 101. The optical member 5 is used as a part or all of the plurality of optical members 102, 103, and 104. The lens unit 101 guides incident light through the plurality of optical members 102, 103, and 104 to an imaging element 106 of the camera mounted on the information terminal 203.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220356, filed Dec. 16, 2024, which is hereby incorporated by reference herein in its entirety.

What is claimed is:

1. A method for manufacturing a member, the method comprising:
a heating step of heating a preform to form a temperature distribution in the preform; and
a molding step of pressing the preform, in which the temperature distribution has been formed, with a die to mold the member from the preform,
wherein the preform has a first region and a second region outside the first region, and
wherein the heating step forms the temperature distribution in which a temperature of the second region is lower than a temperature of the first region.

2. The method for manufacturing a member according to claim 1, wherein the heating step forms the temperature distribution in which the temperature of the second region is lower than the temperature of the first region by 10° C. or more.

3. The method for manufacturing a member according to claim 1, wherein the heating step forms the temperature distribution in which the temperature of the second region is equal to or higher than a glass transition temperature of the preform.

4. The method for manufacturing a member according to claim 1,
wherein the preform has a circular shape as a planar shape; and
wherein the second region is a region outside the first region occupying 90% of an outer diameter of the preform.

5. The method for manufacturing a member according to claim 1,
wherein the second region is a peripheral region of the preform; and
wherein the first region is a region surrounded by the second region.

6. The method for manufacturing a member according to claim 1,
wherein the heating step heats the preform using electromagnetic waves, and
wherein the second region has an absorption rate of the electromagnetic waves that is lower than that of the first region.

7. The method for manufacturing a member according to claim 6, wherein a film having an absorption rate of the electromagnetic waves lower than that of the preform is formed on the second region.

8. The method for manufacturing a member according to claim 7, wherein the film has the absorption rate of the electromagnetic waves that is lower than that of the preform by 50% or more with respect to a peak wavelength of the electromagnetic waves.

9. The method for manufacturing a member according to claim 7, the method comprising a film forming step of forming the film on a surface of the second region,
wherein the film forming step forms the film using any one of a vapor deposition, a sputtering, a chemical vapor deposition, a wet coating, and a brush coating.

10. The method for manufacturing a member according to claim 1, wherein the heating step forms the temperature distribution by irradiating the first region with a larger amount of energy than the second region.

11. The method for manufacturing a member according to claim 10,
wherein the heating step heats the preform by irradiating the preform with the energy using a heater,
wherein the heater has a first portion that heats the first region and a second portion that heats the second region; and
wherein a first distance between the first portion and the first region is shorter than a second distance between the second portion and the second region.

12. The method for manufacturing a member according to claim 10,
wherein the heating step heats the preform by irradiating the preform with the energy using a heater,
wherein the heater has a first portion that heats the first region and a second portion that heats the second region; and
wherein a heat insulating member is provided between the second portion and the second region.

13. The method for manufacturing a member according to claim 10,
wherein the heating step heats the preform by irradiating the preform with the energy using a heater,
wherein the heater includes a heating element including a first portion that heats the first region and a second portion that heats the second region,
wherein a width of the first portion is narrower than a width of the second portion, and
wherein a density of the heating element is lower in the second portion than in the first portion.

14. The method for manufacturing a member according to claim 10,
wherein the heating step heats the preform by irradiating the preform with the energy using a heater,
wherein the heater includes a first electric heating element that heats the first region and a second electric heating element that heats the second region; and
wherein a power density of the second electric heating element is lower than a power density of the first electric heating element.

15. An apparatus for manufacturing a member, the apparatus comprising:
a die;
a heating unit configured to heat a preform to form a temperature distribution in the preform; and
a drive system configured to press the preform, in which the temperature distribution has been formed, with the die to mold the member from the preform or to demold the member from the die,
wherein the preform has a first region and a second region outside the first region, and
wherein the heating unit forms the temperature distribution in which a temperature of the second region is lower than a temperature of the first region.

16. A preform for use in press molding, the preform comprising:
a first region; and
a second region outside the first region,
wherein a film having an absorption rate of electromagnetic waves lower than that of the preform is formed in the second region.

17. A member comprising:
a main body; and
a film adhering to the main body, the film having an absorption rate of electromagnetic waves lower than that of the main body,
wherein the main body has a first region and a second region outside the first region, and
wherein a third region to which the film adheres and a fourth region where the main body is exposed are alternately arranged in the second region.

18. A lens unit comprising:
the member according to claim 17; and
a support that supports the member,
wherein the member is a lens.

19. Equipment comprising:
the lens unit according to claim 18; and
a housing that houses the lens unit.

20. A non-transitory computer-readable recording medium storing a program executable to perform the method according to claim 1.
